(19) United States
(12) Patent Application Publication
(10) Pub. No.: US 2014/0362195 A1
(43) Pub. Date: Dec. 11, 2014

(54) ENHANCED 3-DIMENSIONAL (3-D) NAVIGATION

(71) Applicants: Victor Ng-Thow-Hing, Sunnyvale, CA (US); Karlin Bark, Menlo Park, CA (US); Cuong Tran, Santa Clara, CA (US)

(72) Inventors: Victor Ng-Thow-Hing, Sunnyvale, CA (US); Karlin Bark, Menlo Park, CA (US); Cuong Tran, Santa Clara, CA (US)

(73) Assignee: HONDA MOTOR, CO., LTD., Tokyo (JP)

(21) Appl. No.: 14/321,105

(22) Filed: Jul. 1, 2014

Related U.S. Application Data
(63) Continuation-in-part of application No. 14/041,614, filed on Sep. 30, 2013.
Application No. 14/041,614 is a continuation-in-part of application No. 13/832,918, filed on Mar. 15, 2013.

(51) Int. Cl. G06K 9/00; H04N 7/18; G02B 27/01

(52) U.S. Cl. CPC G06K 9/00791; G02B 27/01; G06K 9/00335; H04N 7/18
USPC 348/51

(57) ABSTRACT

One or more embodiments of techniques or systems for 3-dimensional (3-D) navigation are provided herein. A heads-up display (HUD) component can project, render, display, or present graphic elements on focal planes around an environment surrounding a vehicle. The HUD component can cause these graphic elements to appear volumetric or 3-D by moving or adjusting a distance between a focal plane and the vehicle. Objects within the environment may be tracked, identified, and corresponding graphic elements may be projected on, near, or around respective objects. For example, the HUD component may project graphic elements or pointers on pedestrians such that it may alert the driver or operator of the vehicle of their presence. These pointers may stay ‘stuck’ on the pedestrian as he or she is walking within the environment. Metadata associated with objects may be presented, such as address information, ratings, telephone numbers, logos, etc.

### CROSS-REFERENCE TO RELATED APPLICATIONS

This application is a continuation-in-part (CIP) of pending U.S. Non-Provisional patent application Ser. No. 14/041,614 (Attorney Docket No.: 107745.54CIP1) entitled “3-DIMENSIONAL (3-D) NAVIGATION”, filed on Sep. 30, 2013, which is a continuation-in-part (CIP) of pending U.S. Non-Provisional patent application Ser. No. 13/832,918 (Attorney Docket No.: HRA-36332.01) entitled “VOLUMETRIC HEADS-UP DISPLAY WITH DYNAMIC FOCAL PLANE”, filed on Mar. 15, 2013. The entirety of the above-noted application(s) are incorporated by reference herein.

### BACKGROUND

To improve driver convenience, a vehicle may be a provided with a heads-up display (HUD) which displays information to the driver. The information displayed by the HUD may be projected onto the windshield of the vehicle to present the information in the driver's view while the driver is driving. By displaying the information in the driver's view, the driver does not need to look away from the windshield (e.g., toward an instrument display on a center dashboard) while driving to see the presented information.

The HUD may present vehicle information typically displayed in the vehicle's center dashboard, such as information related to the vehicle's speed, fuel level, engine temperature, etc. Additionally, the HUD may present map information and communication events (e.g., navigation instructions, driving instructions, warnings, alerts, etc.) to the driver. The vehicle HUD may present the information to the driver in a manner similar to that employed by the vehicle dashboard, such as by displaying gauges and text boxes which appear as graphic elements on the windshield. Additionally, the vehicle HUD may present augmented reality graphic elements which augment a physical environment surrounding the vehicle with real-time information.

However, existing HUD devices used in vehicles may not be capable of presenting augmented reality graphic elements with consistent depth cues. Accordingly, augmented reality graphic elements presented by existing vehicle HUDs may be presented as superficial overlays.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

According to one aspect, a vehicle heads-up display device for displaying graphic elements in view of a driver of a vehicle includes a first projector and a first actuator. The first projector can be configured to project a first graphic element on a first focal plane in view of the driver. The first focal plane may be oriented substantially perpendicularly to a line-of-sight of the driver and a distance away from the vehicle. The first projector can be mounted on the first actuator. The first actuator may be configured to linearly move the first projector. Linearly moving the first projector can cause the first focal plane of the first graphic element to move in a direction of the line-of-sight of the driver.

According to another aspect, a vehicular heads-up display system includes a vehicle heads-up display device and a controller. The vehicle heads-up display device displays graphic elements in view of a driver of a vehicle, and includes a first projector and a second projector. The first projector can be configured to project a first graphic element on a first focal plane in view of the driver. The first focal plane can be oriented substantially perpendicularly to a line-of-sight of the driver. The first projector can be configured to move the first focal plane in a direction of the line-of-sight of the driver. The second projector can be configured to project a second graphic element on a second focal plane in view of the driver. The second focal plane may be static and oriented substantially parallel to a ground surface. The controller can be configured to communicate with one or more associated vehicle control systems and to control the vehicle heads-up display device to display the first and second graphic elements based on communication with one or more of the associated vehicle control systems.

According to yet another aspect, a method for presenting augmented reality graphic elements in a vehicle heads-up display includes projecting a first graphic element on a first focal plane in view of a driver, and a second graphic element on a second focal plane in view of the driver. The first focal plane may be oriented substantially perpendicularly to a line-of-sight of the driver, and the second focal plane may be static and oriented substantially parallel to a ground surface. The method can include moving or adjusting the first focal plane in a direction of the line-of-sight of the driver.

One or more embodiments of techniques or systems for 3-dimensional (3-D) navigation are provided herein. For example, a system for 3-D navigation can project a graphic element or avatar that appears to move in view of an occupant of a vehicle. In one or more embodiments, a heads-up display component (HUD) component can be configured to project the graphic element or avatar on one or more focal planes in an environment surrounding a vehicle. In other words, the HUD component can project graphic elements or avatars at adjustable distances or adjustable focal planes to provide an occupant of a vehicle with the perception that an avatar or graphic element is moving, flying, animated, etc.

As an example, the HUD component may be configured to ‘animate’ or provide movement for an avatar by sequentially projecting the avatar on one or more different focal planes. Projection on to these focal planes may be achieved utilizing an actuator to move a projector of the HUD component, for example. As a result of this, depth cues such as accommodation and vergence associated with a graphic element or avatar are generally preserved. When a route is generated from a first location to a second location, the HUD component can generate one or more graphic elements for a driver or occupant of a vehicle to ‘follow’. Because the HUD component can project onto multiple focal planes or move projected graphic elements from one focal plane to another, graphic elements or projected images can appear much more ‘real’, similar to an image seen in a mirror.

When an occupant of a vehicle requests navigation guidance, a graphic element, such as an avatar, may be provided. The avatar may appear to move, glide, fly, etc. in front of the vehicle, similar to what an occupant or driver would see if they were following a friend's vehicle, for example. Additionally, the avatar could appear to navigate around obstructions, obstacles, pedestrians, debris, potholes, etc. as a real vehicle would. In one or more embodiments, the avatar could ‘drive’, move, appear to move, etc. according to real-time traffic. For example, if a route takes a driver or a vehicle across train tracks, the avatar may stop at the train tracks when a train is crossing. As another example, the avatar may change lanes in a manner such that the avatar does not appear to ‘hit’ another vehicle or otherwise interfere with traffic.

In one or more embodiments, a sensor component may track or detect one or more objects or information associated with the environment in which a vehicle is travelling. This information may be passed to the vehicle control component. The vehicle control component may aggregate, collect, or receive information about the environment around the vehicle from different sources. A controller component may utilize this information to make decisions regarding whether or not to project a graphic element at a location or on a focal plane and attributes or models to utilize when rendering the graphic element. A HUD component may render or project the graphic element based on the controller component decision.

For example, if a sensor component detects a pedestrian in a crosswalk across a road segment along a route which involves having the vehicle turn onto that road segment, the controller component may order or command the HUD component to project a graphic element on or around the pedestrian to alert a driver or occupant of the vehicle of the presence of the pedestrian. Further, the sensor component may actively track the pedestrian such that the HUD component may project graphic elements, such as pointers, which follow or track the pedestrian in real-time as he or she crosses the crosswalk. Additionally, the controller component may identify or recognize when the pedestrian has finished crossing or steps onto a sidewalk and communicate to the HUD component to cease projecting graphic elements for the pedestrian.

A system for 3-D navigation may enable identification or projection of early warning graphic elements. For example, if a driving is turning from a first road segment to a second road segment (e.g., making a left turn or a right turn from one road to another), information received by the vehicle control component, such as environment information or traffic condition information may be utilized by the controller component to make a determination that an early warning graphic element should be rendered for an occupant or driver of a vehicle. In other words, the controller component may order or command the HUD component to render a graphic element which points to an object (e.g., a hazard, road condition, etc.) which may not necessarily be in view of the driver. Here, when looking out of the windshield of the vehicle, a driver may not see a hazard on his or her left, for example. However, the HUD component may project a graphic element which directs the driver's attention to his or her left, (e.g., off the windshield or outside of the view of the driver). In this way, safety may be promoted by providing drivers or occupants of a vehicle with advance notice of objects within an environment.

Additionally, the HUD component may project or render details pertaining to objects within the environment, such as a name of a business, address markers, final destination markers, parking graphic elements, reviews, etc.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example schematic diagram of a vehicular heads-up display system, according to one or more embodiments.

FIG. 2 is an illustration of an example schematic diagram of a vehicle in which a vehicular heads-up display system is provided, according to one or more embodiments.

FIG. 3 is an illustration of an example side view of a vehicle and four focal planes on which graphic elements are projected by a vehicular heads-up display system, according to one or more embodiments.

FIG. 4 is an illustration of an example view of a driver while driving a vehicle, looking through a windshield of the vehicle, and exemplary graphic elements projected by a vehicular heads-up display system, according to one or more embodiments.

FIG. 5 is an illustration of an example component diagram of a system for 3-D navigation, according to one or more embodiments.

FIG. 6 is an illustration of an example flow diagram of a method for 3-D navigation, according to one or more embodiments.

FIG. 7A is an illustration of an example avatar for 3-D navigation, according to one or more embodiments.

FIG. 7B is an illustration of an example avatar for 3-D navigation, according to one or more embodiments.

FIG. 8A is an illustration of an example avatar for 3-D navigation, according to one or more embodiments.

FIG. 8B is an illustration of an example avatar for 3-D navigation, according to one or more embodiments.

FIG. 9A is an illustration of an example avatar for 3-D navigation, according to one or more embodiments.

FIG. 9B is an illustration of an example avatar for 3-D navigation, according to one or more embodiments.

FIG. 10A is an illustration of an example scenario associated with 3-D navigation, according to one or more embodiments.

FIG. 10B is an illustration of an example scenario associated with 3-D navigation, according to one or more embodiments.

FIG. 11A is an illustration of an example scenario associated with 3-D navigation, according to one or more embodiments.

FIG. 11B is an illustration of an example scenario associated with 3-D navigation, according to one or more embodiments.

FIG. 12A is an illustration of an example scenario associated with 3-D navigation, according to one or more embodiments.

FIG. 12B is an illustration of an example scenario associated with 3-D navigation, according to one or more embodiments.

FIG. 13A is an illustration of an example scenario associated with 3-D navigation, according to one or more embodiments.

FIG. 13B is an illustration of an example scenario associated with 3-D navigation, according to one or more embodiments.

FIG. 14A is an illustration of an example scenario associated with 3-D navigation, according to one or more embodiments.

FIG. 14B is an illustration of an example scenario associated with 3-D navigation, according to one or more embodiments.

FIG. 15 is an illustration of an example scenario associated with 3-D navigation, according to one or more embodiments.

FIG. 16A is an illustration of an example scenario associated with 3-D navigation, according to one or more embodiments.

FIG. 16B is an illustration of an example scenario associated with 3-D navigation, according to one or more embodiments.

FIG. 17A is an illustration of an example scenario associated with 3-D navigation, according to one or more embodiments.

FIG. 17B is an illustration of an example scenario associated with 3-D navigation, according to one or more embodiments.

FIG. 18A is an illustration of an example scenario associated with 3-D navigation, according to one or more embodiments.

FIG. 18B is an illustration of an example scenario associated with 3-D navigation, according to one or more embodiments.

FIG. 19A is an illustration of an example scenario associated with 3-D navigation, according to one or more embodiments.

FIG. 19B is an illustration of an example scenario associated with 3-D navigation, according to one or more embodiments.

FIG. 20A is an illustration of an example scenario associated with 3-D navigation, according to one or more embodiments.

FIG. 20B is an illustration of an example scenario associated with 3-D navigation, according to one or more embodiments.

FIG. 21 is an illustration of an example flow diagram of a method for 3-D navigation, according to one or more embodiments.

FIG. 22 is an illustration of an example computer-readable medium or computer-readable device including processor-executable instructions configured to embody one or more of the provisions set forth herein, according to one or more embodiments.

FIG. 23 is an illustration of an example computing environment where one or more of the provisions set forth herein are implemented, according to one or more embodiments.

### DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

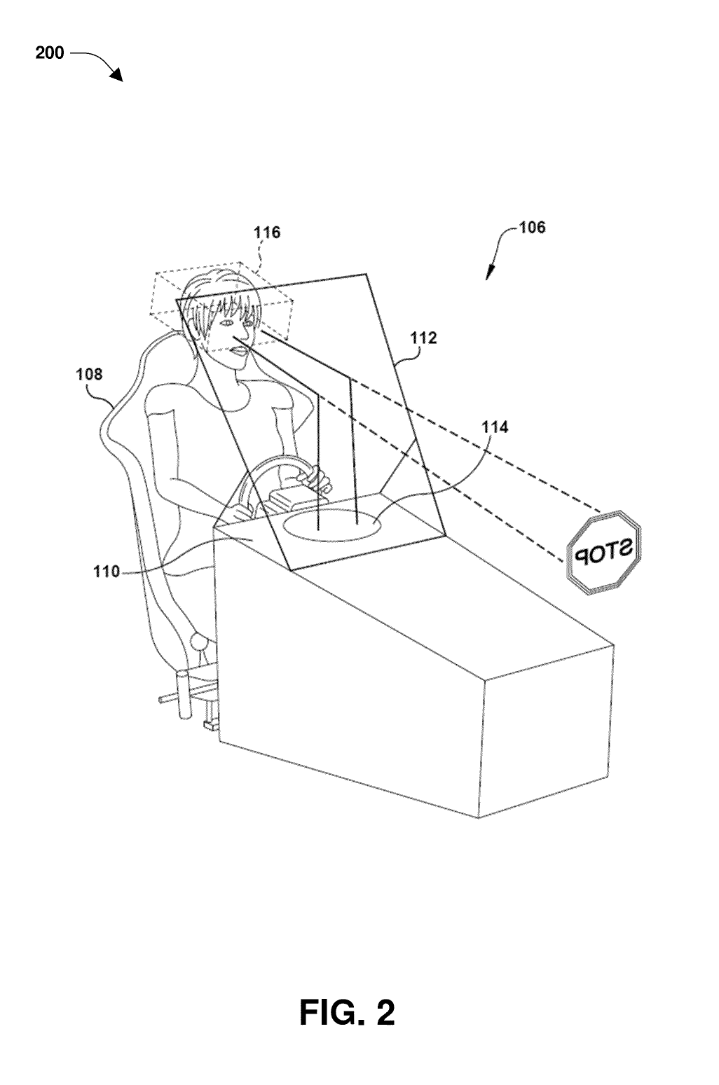

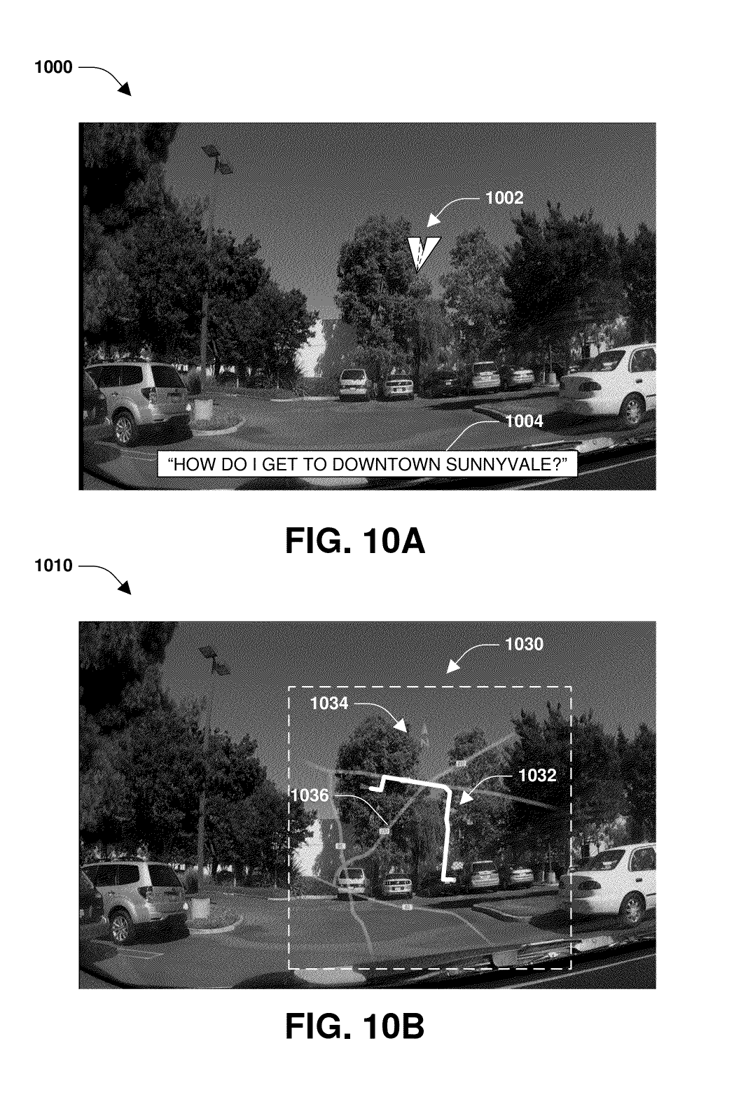

For one or more of the figures herein, one or more boundaries, such as boundary 116 of FIG. 2 or boundary 1030 of FIG. 10B, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

Graphic elements visually placed on environmental elements in the direct view of a driver by a vehicular HUD device are often called contact-analog or conformal augmented reality graphic elements. Successfully presenting contact-analog augmented reality graphic elements to the driver of a vehicle may depend on the ability of the vehicular HUD device to correctly reproduce depth cues. These depth cues can include accommodation and vergence. Accommodation is a depth cue where the muscles in the eye actively change the optical power to change focus at different distances. Vergence is the simultaneous or concurrent inward rotation of the eyes towards each other to maintain a single binocular image when viewing an object.

Although examples described herein may refer to a driver of a vehicle, graphic elements may be projected, provided, rendered, etc. within view of one or more other occupants of a vehicle, such as passengers, etc. To this end, these examples are not intended to be limiting, and are merely disclosed to illustrate one or more exemplary aspects of the instant application.

When a HUD device displays a graphic element on a windshield of a vehicle, accommodation may cause the human eye to shift between environmental elements and information displayed by the HUD device. Vergence causes the eyes to converge to points beyond the windshield into the environment, which may lead to the appearance of a double image of the HUD graphic element displayed on the windshield. Accordingly, to render contact-analog augmented reality graphic elements with correctly reproduced depth cues, graphic elements should be rendered on the same space as the real environment (e.g., at corresponding focal planes), rather than on the windshield of the vehicle.

A vehicle heads-up display device for displaying graphic elements in view of a driver of a vehicle while the driver views an environment through a windshield is provided. The heads-up display device can include one or more projectors that project a graphic element on a frontal focal plane in view of the driver while the driver views the environment through the windshield, and one or more projectors that project a graphic element on a ground-parallel focal plane in view of the driver while the driver views the environment through the windshield. The projector that projects the graphic element on the frontal focal plane may be mounted on an actuator that linearly moves the projector to cause the frontal focal plane to move in a direction of a line-of-sight of the driver. The projector that projects the ground-parallel focal plane may be fixedly arranged such that the ground-parallel focal plane is static.

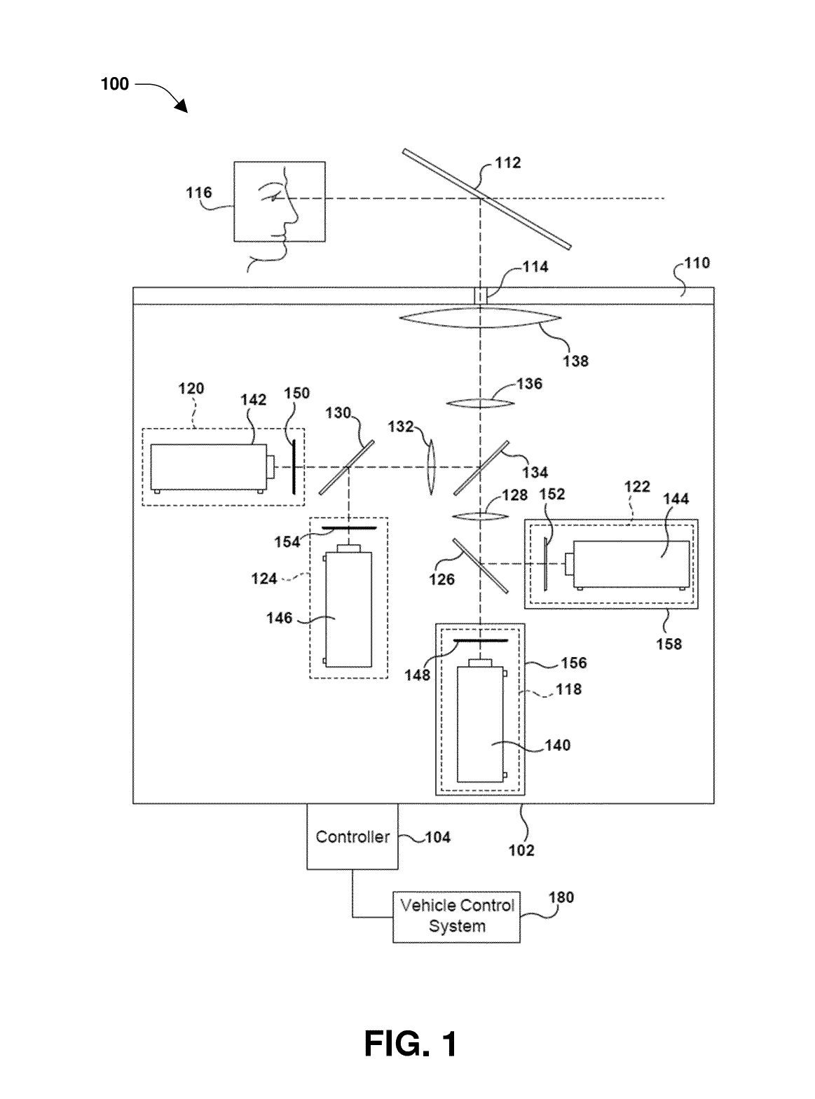

Referring to FIG. 1, a vehicular volumetric heads-up display system 100 (“HUD system 100”) or (“HUD component 100”) capable of rendering volumetric contact-analog augmented reality graphic elements (e.g., 3-dimensional or “3-D” graphic elements rendered into the same space as the real environment) with correctly reproduced depth cues is illustrated. The HUD system 100 includes a vehicle heads-up display device 102 (“HUD device 102”) and a controller 104 (or “controller component 104”). Referring to FIG. 2, the HUD system 100 may be provided in a vehicle 106, which includes a driver seat 108, a dashboard enclosure 110, and a windshield 112.

The configuration of the vehicle 106, with respect to the relative positioning of the driver seat 108, dashboard enclosure 110, and windshield 112, for example, may be conventional. To accommodate the herein-described HUD system 100, the dashboard enclosure 110 defines a housing space in which the HUD system 100 is housed. Further, the dashboard enclosure 110 has a HUD exit aperture 114 defined through an upper surface thereof. The HUD system 100 housed in the dashboard enclosure 110 projects graphic elements, such as contact-analog augmented reality graphic elements, through the HUD exit aperture 114 to the windshield 112, which may be used as a display screen for the HUD system 100. As described in further detail below, the augmented reality graphic elements can be rendered to the driver as if in the same space as the real environment.

A driver of the vehicle 106 drives the vehicle 106 while seated in the driver seat 108. Accordingly, the driver may be positionally constrained to a seating position on the driver seat 108 within the vehicle 106. In view of this positional constraint, the HUD system 100 may be designed using an assumption that the driver's view originates from an eye box 116 within the vehicle. The eye box 116 may be considered to include a region of an interior of the vehicle 106 where the driver's eyes are situated while the driver is seated in the driver seat 108.

The eye box 116 may be sized to encompass all possible head positions of the driver regardless of a position and posture of the driver seat 108, or the HUD system 100 may be configured to detect the position and posture of the driver seat 108, and to adjust a position and size of the eye box 116 based thereon. In one or more embodiments, the HUD system 100 may be designed assuming the eye box 116 has a fixed size and is in a fixed position. For example, the eye box may have the following dimensions: 20 cm×10 cm×10 cm. In any event, the HUD system 100 can be configured to present the contact-analog augmented reality graphic elements to the driver when the driver's eyes are within the eye box 116 and the driver is facing/looking in a forward direction through the windshield 112 of the vehicle 106. Although the eye box 116 of FIG. 2 is illustrated for the driver of the vehicle 106, the eye box 116 may be setup to include one or more other occupants of the vehicle. In one or more embodiments, one or more additional eye boxes or HUD devices may be provided for passengers or other occupants, for example.

The HUD device 102 displays one or more graphic elements in view of the driver of the vehicle 106 while the driver views an environment through the windshield 112 of the vehicle 106. Any graphic or environmental elements viewed by the driver through the windshield 112 while the driver's eyes are in the eye box 116 and the driver is facing/looking in the forward direction through the windshield 112 may be considered to be in view of the driver. As used herein, the view of the driver of the vehicle 106 while the driver views an environment through the windshield 112 of the vehicle 106 is intended to include an area viewed through the windshield 112, excluding dashboard displays located within the vehicle 106. In other words, the HUD device 102 presents the graphic elements such that the driver may view the graphic elements without looking away from the road.

Returning to FIG. 1, the HUD device 102 of the HUD system 100 includes a first projector 118, a second projector 120, a third projector 122, and a fourth projector 124. The first projector 118 and the third projector 122 share a first beam splitter 126 and a first objective lens 128, while the second projector 120 and fourth projector 124 share a second beam splitter 130 and a second objective lens 132. Consequently, the output of the first projector 118 and the third projector 122 can be received in the first beam splitter 126 and combined into a singular output, which is directed to (and through) the first objective lens 128. Similarly, the output of the second projector 120 and the fourth projector 124 can be received in the second beam splitter 130 and combined into a singular output, which is directed to (and through) the second objective lens 132.

The HUD device 102 further includes a third beam splitter 134 disposed downstream from the first and second objective lenses 128, 132 configured to receive the output from the first and second objective lenses 128, 132. The outputs from the first and second objective lenses 128, 132 can be combined at the third beam splitter 134 into a singular output, which can be a combination of the output of all of the first, second, third, and fourth projectors 118, 120, 122, 124, and directed to (and through) a third objective lens 136 and an ocular lens 138 before being directed out of the HUD exit aperture 114 to the windshield 112, which may be used as the display screen for the HUD system 100.

Each of the first projector 118, the second projector 120, the third projector 122, and the fourth projector 124 include a projector unit 140, 142, 144, 146 and a diffuser screen 148, 150, 152, 154 rigidly fixed a set distance from the projector unit 140, 142, 144, 146 and arranged relative to the projector unit 140, 142, 144, 146 such that light emitted from the projector unit 140, 142, 144, 146 passes through the diffuser screen 148, 150, 152, 154. The projector units 140, 142, 144, 146 can be light-emitting units which project an image or graphic element that passes through the associated diffuser screen 148, 150, 152, 154. The diffuser screens 148, 150, 152, 154 serve as a luminous image source (or object) for the rest of the optical system of the HUD device 102, and ensure that much of the light leaving the diffuser screens 148, 150, 152, 154 falls into the optics following the diffuser screens 148, 150, 152, 154 (e.g., the first beam splitter 126, the first objective lens 128, the second beam splitter 130, the second objective lens 132, the third beam splitter 134, the third objective lens 136, and the ocular lens 138), while spreading out light so that it eventually fills out the eye-box 116 so that brightness of the image or graphic element(s) stays constant while the driver's head moves within the eye box 116. Accordingly, use of the diffuser screens 148, 150, 152, 154 substantially prevents different parts of the image or graphic element(s) from being visible from different points within the eye box 116, and thereby substantially prevents the occurrence of different visual behavior with slight head movement.

The projector units 140, 142, 144, 146 may take the form of any light-emitting unit suitable for the herein-described use. The projector units 140, 142, 144, 146 may take the form of any light-emitting unit capable of projecting an image or graphic element according to the herein-described use(s). Similarly, the diffuser screens 148, 150, 152, 154 may take the form of any light diffusing screen suitable for the herein-described use(s).

The first projector 118 can be mounted on a first actuator 156 in the HUD device 102. The first actuator 156 can be a linear actuator capable of moving the first projector 118 in a linear direction toward and away from the first beam splitter 126. Additionally, the third projector 122 can be mounted on a second actuator 158 in the HUD device 102. The second actuator 158 can be a linear actuator capable of moving the third projector 122 in a linear direction toward and away from the first beam splitter 126. The first and second actuators 156, 158 may take the form of any linear actuators suitable for the herein-described use. The ability of the first projector 118 and the third projector 122 to linearly move allows the first projector 118 and the third projector 122 to project graphic elements on dynamic or movable focal planes. In contrast to the first and third projectors 118, 122, the second and fourth projectors 120, 124 can be fixedly arranged in the HUD device 102, and therefore project graphic elements on static focal planes.

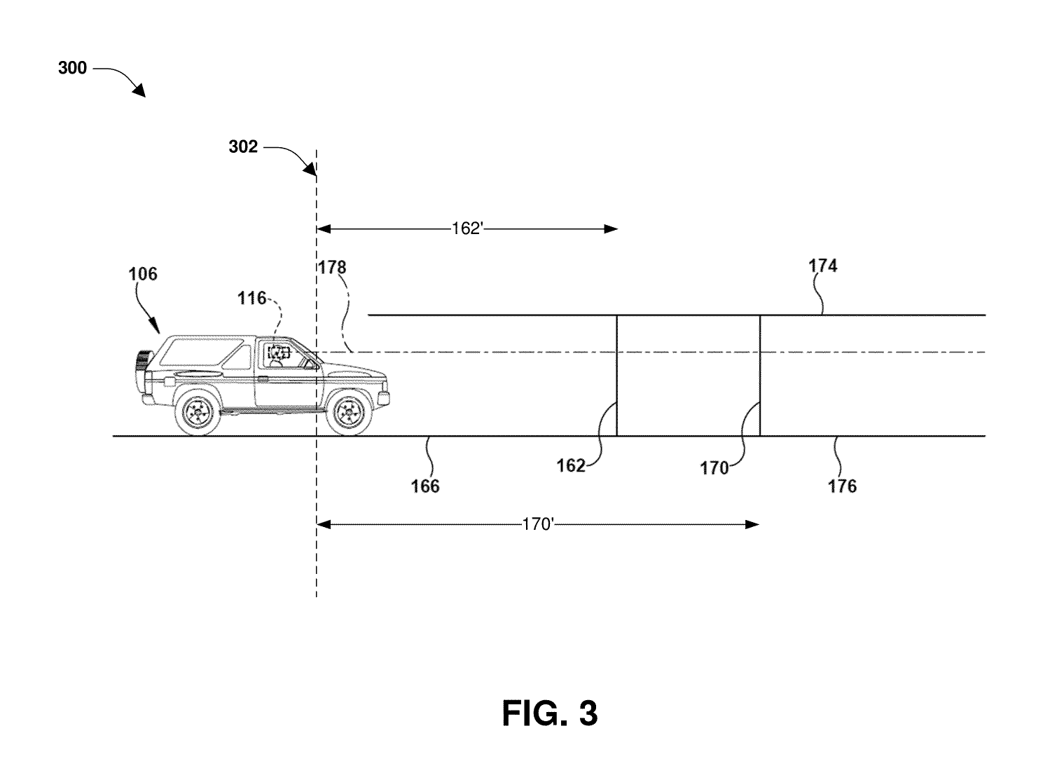

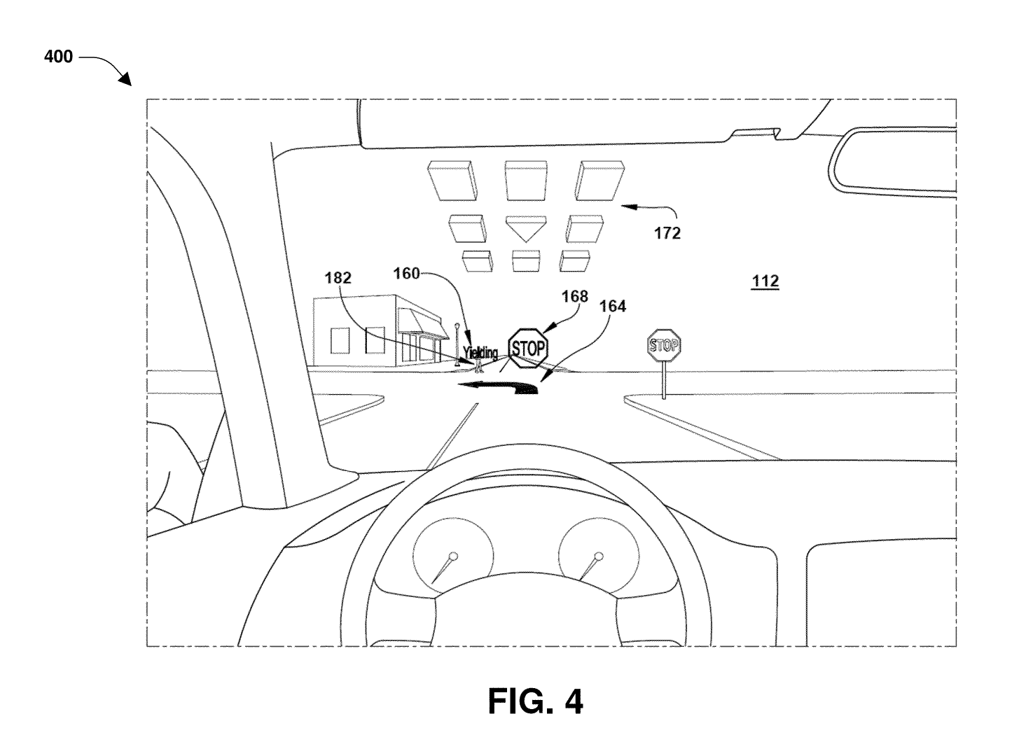

Using the first, second, third, and fourth projectors 118, 120, 122, 124, the HUD device 102 may render graphic elements (contact-analog augmented reality graphic elements or otherwise) in four distinct focal planes in the environment viewed by the driver through the windshield 112. In this regard, the first projector 118 can be configured to project a first graphic element 160 in a first focal plane 162, the second projector 120 can be configured to project a second graphic 164 element in a second focal plane 166, the third projector 122 can be configured to project a third graphic element 168 in a third focal plane 170, and the fourth projector 124 can be configured to project a fourth graphic element 172 in a fourth focal plane 174 (as will be described with reference to FIGS. 3 and 4). All of the first, second, third, and fourth graphic elements 160, 164, 168, 172, and their associated first, second, third, and fourth focal planes 162, 166, 170, 174, can be rendered in the environment in view of the driver as the driver is driving the vehicle 106 and the driver's eyes are in the eye box 116 while the driver is looking in a forward direction through the windshield 112.

Referring to FIG. 3 and FIG. 4, the projection of the first, second, third, and fourth graphic elements 160, 164, 168, 172 on the first, second, third, and fourth focal planes 162, 166, 170, 174 will be described with reference to a ground surface 176 and a line-of-sight 178 of the driver. In this regard, the ground surface 176 is a surface of a road in front of the vehicle 106. For the purposes of the instant description, the ground surface 176 will be assumed to be a substantially planar surface. The line-of-sight 178 of the driver is a line extending substantially parallel to the ground surface 176 from the eye box 116 in the forward direction. As used herein, a direction of the line-of-sight 178 is a direction extending toward and away from the driver and the vehicle 106 along the line-of-sight 178.

The first focal plane 162 is a frontal focal plane which may be oriented substantially perpendicularly to the line-of-sight 178 of the driver. The third focal plane 170 is also a frontal focal plane which may be oriented substantially perpendicularly to the line-of-sight 178 of the driver. The first and third focal planes 162, 170 can be dynamic focal planes which are movable in the direction of the line-of-sight 178, both in the forward direction (away from the vehicle 106) and in a rearward direction (toward the vehicle 106). The second focal plane 166 is a ground-parallel focal plane which may be oriented substantially parallel to the ground surface 176, and may be disposed on the ground surface 176 such that the second focal plane 166 is a ground focal plane. The fourth focal plane 174 is also a ground-parallel focal plane which may be oriented substantially parallel to the ground surface 176, and is disposed above the ground surface 176. The fourth focal plane 174 may be disposed above the ground surface 176 and the line-of-sight 178 of the driver to be a sky or ceiling focal plane. As a result, the second and fourth focal planes 166, 174 may be static focal planes.

Referring to FIG. 4, the first, second, third, and fourth graphic elements 160, 164, 168, 172 may be used to present different information to the driver. The exact type of information displayed by the first, second, third, and fourth graphic elements 160, 164, 168, 172 may vary. For exemplary purposes, the first graphic element 160 and third graphic element 168 may present a warning to the driver instructing the driver to yield to a hazard or obstacle, or may present a navigation instruction or driving instruction associated with rules of the road (e.g., a STOP sign, a YIELD sign, etc.). The second graphic element 164 and fourth graphic element 172 may present navigation instructions to the driver as a graphic overlay presented on the ground surface 176, or may present a vehicle-surrounding indicator to the driver. The first, second, third, and fourth graphic elements 160, 164, 168, 172 may present information or graphic elements to the driver which are different than those described herein, and that a subset of the first, second, third, and fourth graphic elements 160, 164, 168, 172 may be presented.

Returning to FIG. 1, the controller 104 may include one or more computers, (e.g., arithmetic) processors, or any other devices capable of communicating with one or more vehicle control systems 180 and controlling the HUD device 102. One or more of the vehicle control systems 180 (herein, “vehicle control system 180” or “vehicle control component 180”) may take the form(s) of any vehicle control system 180 used to actively or passively facilitate control of the vehicle 106. The vehicle control system 180 may include or communicate with one or more sensors (not shown) which detect driving and environmental conditions related to the operation of the vehicle 106.

With general reference to the operation of the HUD system 100, the controller 104 communicates with the vehicle control system 180, and based on the communication with the vehicle control system 180, determines the type and position of graphic elements to be presented to the driver of the vehicle 106. The controller 104 determines the type of graphic element to be presented as the first, second, third, and fourth graphic elements 160, 164, 168, 172 by the first, second, third, and fourth projectors 118, 120, 122, 124, and controls the first, second, third, and fourth projectors 118, 120, 122, 124 to project the first, second, third, and fourth graphic elements 160, 164, 168, 172 as the determined graphic elements. The controller 104 can determine a target first graphic element position and a target third graphic element position as target positions at which the first and third graphic elements 160, 168 should be rendered in the environment to the driver. The controller 104 then controls the first and second actuators 156, 158 to linearly move the first and third projectors 118, 122 such that the first and third focal planes 162, 170 can be moved to the target first and third graphic element positions, respectively.

Accordingly, the first projector 118 projects the first graphic element 160 on the first focal plane 162, which may be oriented substantially perpendicularly to the line-of-sight of the driver, and can be movable toward and away from the vehicle 106 in the direction of the line-of-sight 178 of the driver through linear movement of the first projector 118 by the first actuator 156. The second projector 120 projects the second graphic element 164 on the second focal plane 166, which is static and oriented parallel to the ground surface 176 and disposed on the ground surface 176. The third projector 122 projects the third graphic element 168 on the third focal plane 170, which may be oriented substantially perpendicularly to the line-of-sight of the driver, and be movable or adjustable toward and away from the vehicle 106 in the direction of the line-of-sight 178 of the driver through linear movement of the third projector 122 by the second actuator 158. The fourth projector 124 projects the fourth graphic element 172 on the fourth focal plane 174, which is static, oriented parallel to the ground surface 176, and can be disposed above the line-of-sight 178 of the driver. The controller 104 controls the first and second actuators 156, 158 to move the first and third projectors 118, 122 to move the first and third focal planes 162, 170.

By having the first and third projectors 118, 122 project the first and third graphic elements 160, 168 on the movable first and third focal planes 162, 170 which are oriented substantially perpendicular to the line-of-sight 178 of the driver, focus of objects at different distances from the vehicle 106 may be adjusted. This may facilitate the provision of correct depth cues to the driver for the first and third graphic elements 160, 168, especially since the HUD system 100 may be a vehicular application, with the vehicle 106 serving as a moving platform.

While the second and fourth projectors 120, 124 project the second and fourth graphic elements 164, 172 on the static second and fourth focal planes 166, 174, the second and fourth focal planes 166, 174 may be continuous. To make the second and fourth focal planes 166, 174 parallel to the ground surface 176, the diffuser screens 150, 154 of the second and fourth projectors 120, 124 may be tilted. Since the optical system of the HUD device 102 has very low distortion and is nearly telocentric for images in a ground-parallel focal plane, light rays are close to parallel with the optical axis, which allows the projected second and fourth graphic elements 164, 172 to be projected or rendered without distorting or changing the magnification while the second and fourth focal planes 166, 174 are tilted. The resulting second and fourth graphic elements 164, 172 therefore appear on a continuous focal plane (the second and fourth focal planes 166, 174) parallel to the ground surface 176. In this regard, the second and fourth graphic elements 164, 172 may be rendered with an actual 3-dimensional (3-D) volumetric shape, instead of as line segments, to add monocular cues to strengthen depth perception.

The continuous, static second and fourth focal planes 166, 174 facilitate driver depth perception with regard to the second and fourth graphic elements 164, 172. The continuous, static second and fourth focal planes 166, 174 allow for correct generation of real images or graphic elements through the forward-rearward direction in 3-D space (e.g., the direction of the line-of-sight 178 of the driver), allowing proper motion parallax cues to be generated. Accordingly, as the driver's head shifts from side-to-side or up-and-down, the second and fourth graphic elements 164, 172 appear to the driver to be fixed in position in the environment, rather than moving around. Consequently, the HUD system 100 does not need a head-tracking function to compensate for movement of the driver's head.

With regard to the previously-listed exemplary information which may be presented to the driver, the vehicle control system 180 may include processing and sensors capable of performing the following functions: hazard or obstacle detection; navigation; navigation instruction; and vehicle surrounding (e.g., blind-spot) monitoring. The vehicle control system 180 may include processing and sensors capable of performing other vehicle control functions (e.g., highway merge assist, etc.), which may alternatively or additionally be tied to information presented to the driver using the HUD system 100. Regardless of the functions performed by the vehicle control system 180, the precise manner of operation of the vehicle control system 180 to perform the functions, including the associated sensors and processing, may not be relevant to the operation of the HUD system 100.

The controller 104 communicates with the vehicle control system 180, and receives therefrom inputs related to the operation of the vehicle 106 and associated with the above-listed (or other) functions. The controller 104 then controls the HUD device 102 based on the inputs received from the vehicle control system 180. In this regard, one or both of the controller 104 and the vehicle control system 180 may determine: the type of graphic element to be displayed as the first, second, third, and fourth graphic elements 160, 164, 168, 172; the location of the first, second, third, and fourth graphic elements 160, 164, 168, 172; and which of the first, second, third, and fourth graphic elements 160, 164, 168, 172 are to be displayed. These determinations may be based on one or more vehicle functions employed by the driver, such as whether the driver is using the navigation function.

Regardless of which of the controller 104 or the vehicle control system 180 are used to make these determinations, the controller 104 controls the HUD device 102 to display the appropriate graphic elements at the appropriate locations. This can include controlling the first, second, third, and fourth projectors 118, 120, 122, 124 to project the appropriate first, second, third, and fourth graphic elements 160, 164, 168, 172. This can include controlling the first and second actuators 156, 158 to linearly move the first and third projectors 118, 122, to move the first and third focal planes 162, 170 to the appropriate (e.g., target) positions. For example, one or more actuators, such as 156, 158, may be configured to move one or more of the focal planes, such as 162, 170. For example, with reference to the third focal plane 170, a distance between the third focal plane 170 and a windshield of the vehicle 106 (e.g., at 302) may be adjusted by adjusting distance 170′. Similarly, distance 162′ may be adjusted to change a target position for focal plane 162.

In view of the previously-listed exemplary information associated with the first, second, third, and fourth graphic elements 160, 164, 168, 172, operation of the HUD system 100 will be described with reference to the vehicle 106 having the vehicle control system 180 which enables the following functions: a hazard or obstacle detection and warning function; a navigation function; a navigation instruction function; and a vehicle surrounding (e.g., blind-spot) monitoring function. Again, the vehicle 106 may have a subset of these functions or additional functions, and that the HUD system 100 may be employed with reference to the subset or additional functions. The description of the HUD system 100 with reference to these functions is merely exemplary, and are used to facilitate description of the HUD system 100. Though one of or both of the controller 104 and the vehicle control system 180 may make determinations associated with the operation of the HUD system 100, in the below description, the controller 104 is described as being configured to make determinations based on input received from the vehicle control system 180.

Information related to the obstacle detection and warning function may be presented to the driver as a contact-analog augmented reality graphic element projected by the first projector 118 of the HUD device 102. In this regard, the vehicle control system 180 may detect various obstacles in the roadway on which the vehicle 106 is travelling. For example, obstacles may include pedestrians crossing the roadway, other vehicles, animals, debris in the roadway, potholes, etc. The detection of these obstacles may be made by processing information from the environment sensed by sensors (not shown) provided on the vehicle 106. Further, obstacle detection may be carried out in any manner.

When an obstacle is detected, the vehicle control system 180 communicates obstacle information to the controller 104. The controller 104 receives the obstacle information from the vehicle control system 180 and determines the type of graphic element to present as the first graphic element 160 and the target first graphic element position based on the received obstacle information. While various types of graphic elements may be used, such as flashing icons, other signs, etc., examples herein will be described with reference to a “YIELD” sign presented when an obstacle is detected.

Referring to FIG. 4, the obstacle detected by the vehicle control system 180 may be a pedestrian 182 crossing the road on which the vehicle 106 is travelling. In the exemplary view of the driver of FIG. 4, the vehicle 106 is traveling on a road which is being crossed by the pedestrian 182. Accordingly, the vehicle control system 180 can send obstacle information related to the pedestrian 182 to the controller 104. Based on the obstacle information, the controller 104 can determine the type of graphic element to be displayed as the first graphic element 160; in this case, for example, the graphic element can be a “YIELD” sign, although other graphic may be used. The controller 104 can determine the target first graphic element position such that the first graphic element 160 will be projected and rendered to be perceived by the driver to be at a same depth (e.g., focal plane) as the pedestrian 182. Further, the controller 104 can be configured to adjust the target first graphic element position such that the first graphic element 160 ‘tracks’ or ‘follows’ the pedestrian 182, as the pedestrian 182 walks, for example.

The controller 104 then controls the first projector 118 to project the “YIELD” sign as the first graphic element 160, and controls the first actuator 156 to linearly move the first projector 118 such that the first graphic element 160 can be projected and rendered to be perceived by the driver (e.g., while the driver's eyes are in the eye box 116 and the driver is looking in the forward direction through the windshield 112) to be at the same depth as the pedestrian 182. The first actuator 156 can be controlled such that the first graphic element 160 can be projected on the first focal plane 162, which can be positioned at the target first graphic element position and may be oriented substantially perpendicular to the line-of-sight 178.

As the vehicle 106 and the pedestrian 182 travel on the road, the relative distance between the two will change. This change in distance may be communicated to the controller 104 by the vehicle control system 180, the target first graphic element position may be changed accordingly, and the first actuator 156 may be controlled by the controller 104 to move the first focal plane 162 to remain at the (e.g., changed/changing) target first graphic element position. Accordingly, projecting the first graphic element 160 on the first focal plane 162 which may be movable in the direction of the line-of-sight 178 of the driver, the depth cues associated with the first graphic element 160 can be correctly reproduced so that the driver may accurately judge the position of the first graphic element 160 (e.g., the detected obstacle).

Additionally, information related to the navigation function may be presented to the driver as a contact-analog augmented reality graphic element projected by the second projector 120 of the HUD device 102. In this regard, the vehicle control system 180 may, upon receiving a navigation request from the driver (e.g., the input of a desired location), generate a navigation route for the driver to follow to get to the desired location. The navigation route includes a set of driving directions for the driver to follow, including instructions to turn onto streets on the route to the desired location. The navigation function may be carried out in any manner. When the navigation function is activated, the vehicle control system 180 can communicate the driving directions associated with the navigation function to the controller 104.

The controller 104 can receive the driving directions from the vehicle control system 180 and determine the type of graphic element to present as the second graphic element 164. The types of graphic elements associated with the navigation function may include graphic elements which instruct the driver to continue on the current road (e.g., a straight line or arrow), to turn left or right onto an upcoming cross-road (e.g., a left/right arrow or line turning in the appropriate direction), to enter, merge onto, or exit from a highway (e.g., a line or arrow indicating the appropriate path), etc. The controller 104 selects the appropriate graphic element to present as the second graphic element 164 based on the driving direction communicated from the vehicle control system 180.

Referring to the exemplary view of the driver of FIG. 4, the driving direction for the driving route determined by the navigation function of the vehicle control system 180 includes a left-hand turn onto an upcoming street. Accordingly, the controller 104 controls the second projector 120 to generate and project a left-hand turn graphic element as the second graphic element 164 on the second focal plane 166. As shown in FIG. 4, the second focal plane 166 may be oriented parallel to the ground surface 176 and be disposed on the ground surface 176. As noted above, the second projector 120 can be fixedly arranged in the HUD device 102, such that the second focal plane 166 is static. As noted above, the second focal plane 166 may be continuous, such that the second graphic element 164 can be rendered to the driver with appropriate depth cues as a 3-D image.

Similarly, information related to the navigation instruction function may be presented to the driver as a contact-analog augmented reality graphic element projected by the third projector 122 of the HUD device 102. In this regard, the vehicle control system 180 may use sensors or information stored in a database and associated with a map to monitor the road on which the vehicle 106 is traveling, and to determine upcoming navigation instructions associated with travel on that road. For example, the vehicle control system 180 may detect an upcoming required stop, yield, or other condition (herein, collectively referenced as “road condition”) on the road on which the vehicle 106 is traveling. The vehicle control system 180 may determine a navigation instruction associated with the detected road condition (e.g., a stop instruction associated with a stop road condition, etc.). The navigation instruction function may be carried out in any manner, the specifics of which are not necessarily relevant to the operation of the HUD system 100. Additionally, road conditions can include, among other things, traffic on a road segment, obstructions, obstacles, weather conditions, conditions of a surface of a road segment, speed limits associated with a portion of a road or road segment, etc. In other words, road conditions can generally include reasons to speed up, slow down, take a detour, stop, exercise caution, etc. while driving, for example.

The vehicle control system 180 communicates the road condition or the navigation instructions associated with the road condition, as well as information related to a position of the road condition, to the controller 104. The controller 104 can control the third projector 122 to project the third graphic element 168 to communicate information to the driver related to the road condition or associated navigation instruction accordingly. The controller 104 can receive the road condition or navigation instruction information, as well as the position information, from the vehicle control system 180, and determine the type of graphic element to present as the third graphic element 168 and a target third graphic element position.

Various types of graphic elements may be used in conjunction with navigation instruction functions, for example: a STOP sign, a YIELD sign, a ONE WAY sign, a NO TURN ON RED sign, etc. The type of graphic element may be selected to communicate the navigation instruction associated with the road condition. Whichever type of graphic element the controller 104 determines should be used as the third graphic element 168, that graphic element may be projected to appear at the location of the driving condition. In this regard, the target third graphic element position may be determined as a position at which the third graphic element 168 should be rendered in view of the driver based on the position of the detected road condition relative to the vehicle 106.

The controller 104 may be configured to control the third projector 122 to project the appropriate graphic element as the third graphic element 168. The controller can control the second actuator 158 to linearly move the third projector 122 such that the third graphic element 168 is projected and rendered to be perceived by the driver (e.g., while the driver's eyes are in the eye box 116 and the driver is looking in the forward direction through the windshield 112) to be at the same depth (e.g., having a same focal plane) as the road condition. The second actuator 158 can be controlled such that the third graphic element 168 is projected on the third focal plane 170, which can be positioned at the target third graphic element position and oriented substantially perpendicularly to the line-of-sight 178. The controller 104 may control the second actuator 158 to continuously linearly move the third projector 122 such that the third focal plane 170 moves as a distance between the vehicle 106 and the detected road condition (e.g., the target third graphic element position) changes (as detected by the vehicle control system 180 and communicated to the controller 104), for example, as a result of the vehicle 106 driving toward the detected road condition.

In the exemplary view of from the perspective of the driver in FIG. 4, the vehicle 106 is approaching a four-way intersection at which the vehicle 106 should stop. Accordingly, the vehicle control system 180 detects the stop road condition at a position of an entrance of the intersection, and determines the navigation instruction associated with the stop road condition to be a stop instruction. The stop road condition or instruction, as well as the position of the stop road condition, can be communicated to the controller 104, which determines that a STOP sign should be presented as the third graphic element 168. The controller 104 can determine that the third graphic element 168 (e.g., the STOP sign) should appear at the position of the entrance of the four-way intersection. The position of the entrance of the intersection can therefore be determined to be the target third graphic element position.

The controller 104 can control the third projector 122 to project the “STOP” sign as the third graphic element 168, and control the second actuator 158 to move the third projector 122 such that the third graphic element 168 is projected and rendered to be perceived by the driver (e.g., while the driver's eyes are in the eye box 116 and the driver is looking in the forward direction through the windshield 112) to be at the same depth as the entrance of the four-way intersection. The second actuator 158 can be controlled such that the third graphic element 168 can be projected on the third focal plane 170, which is positioned at the target third graphic element position and oriented substantially perpendicularly to the line-of-sight 178. As the vehicle 106 travels on road, the relative distance between the vehicle 106 and the entrance of the four-way intersection will change. This change in distance may be communicated to the controller 104 by the vehicle control system 180, the target third graphic element position may be changed accordingly, and the second actuator 158 may be controlled by the controller 104 to move the third focal plane 170 to remain at the (e.g., changed/changing) target third graphic element position. Accordingly, projecting the third graphic element 168 on the third focal plane 170 which can be movable in the direction of the line-of-sight 178 of the driver, the depth cues associated with the third graphic element 168 may thus be correctly reproduced so that the driver may accurately judge the position of the third graphic element 168 (e.g., the detected road condition).

Information related to the vehicle surrounding (e.g., blind-spot) monitoring function may be presented to the driver by the fourth projector 124 of the HUD device 102. In this regard, the vehicle control system 180 may detect the existence of other vehicles in an area immediately surrounding or surrounding the vehicle 106. The detection of the other vehicles immediately surrounding the vehicle 106 may be made by processing information regarding the surroundings of the vehicle 106 sensed by sensors (not shown) provided on the vehicle 106. The vehicle surrounding determination may be carried out in any manner.

The vehicle surrounding information can be determined by the vehicle control system 180 and communicated to the controller 104. The controller 104 receives the vehicle surrounding information from the vehicle control system 180 and determines how, if at all, to modify the fourth graphic element 172 projected on the fourth focal plane 174. In this regard, the graphic element used as the fourth graphic element 172 to facilitate the vehicle surrounding (e.g., blind-spot) monitoring function may be a vehicle surrounding indicator, shown in FIG. 4.

The vehicle surrounding indicator includes a central marker representing the vehicle 106 and eight surrounding markers representing positions immediately surrounding the vehicle 106. The vehicle control system 180 communicates information about the positions of vehicles in the immediate surroundings of the vehicle 106, and the controller 104 controls the fourth projector 124 to change the fourth graphic element 172 such that one or more of the eight associated surrounding markers are highlighted. The highlighting of the eight surrounding markers indicates to the driver the position of other vehicles in the immediate surroundings of the vehicle 106.

In FIG. 4, the fourth graphic element 172 can be projected on the fourth focal plane 174, which may be oriented parallel to the ground surface 176 and can be disposed above the ground surface 176 and the line-of-sight 178. As noted above, the fourth projector 124 can be fixedly arranged in the HUD device 102, such that the fourth focal plane 174 is static. As noted above, the fourth focal plane 174 can be continuous, such that the fourth graphic element 172 may be rendered to the driver with appropriate depth cues as a 3-D image.

The fourth graphic element 172 may be presented in a form different than the vehicle surrounding indicator of FIG. 4. In any event, the fourth graphic element 172 can be projected onto the fourth focal plane 174, which may be oriented parallel to the ground surface 176 and can be disposed above the ground surface 176 and the line-of-sight 178 of the driver. Accordingly, the fourth graphic element 172 can be provided on the sky focal plane, which may be appropriate since the information communicated by the fourth graphic element 172 need not interact with the environment.

The above-described HUD system 100 can project graphic elements, some of which as contact-analog augmented reality graphic elements, at continuously changing focal distances as well as in ground-parallel focal planes with continuous changing focus from front-to-back in the direction of the line-of-sight 178 of the driver. Accordingly, depth perception cues may be improved, to facilitate focus and increase the attention the driver pays to the environment while simultaneously or concurrently (or near-simultaneously). This enables the driver to observe information presented via the graphic elements as well as the environment. In this regard, through experimentation, the inventors have determined that spatial perception may be greatly influenced by focal cues, and that the focal plane adjusting capability, as well as the capability to show graphic elements on continuous, static ground-parallel focal planes, of the herein-described HUD system 100 improves spatial perception. To this end, a greater improvement in spatial perception is observed when adjusting the focal cues as described herein, than is observed when adjusting a size of a graphic element.

The configuration of the HUD device 102, including the use of the beam splitters 126, 130, 134 and lenses 128, 132, 136, 138, allows the HUD device 102 to have a relatively compact size. Further, the lenses 128, 132, 136, 138 allow a range of depth to expand from a few meters in front of the vehicle 106 to infinity within the physical space allocated for the optics of the HUD device 102. Further still, the beam splitters 126, 130, 134 can be used as optical combiners to merge all of the disparate sets of projected rays from the first, second, third, and fourth projectors 118, 120, 122, 124 through the lenses 128, 132, 136, 138 to combine separate images from the first, second, third, and fourth projectors 118, 120, 122, 124 into one unified image (e.g., or graphic element) projected in view of the driver.

In one or more embodiments, several of the above-disclosed and other features and functions, or alternatives or varieties thereof, may be desirably combined into many other different systems or applications. Additionally, various presently unforeseen or unanticipated alternatives, modifications, variations, or improvements therein may be subsequently made by those skilled in the art which are also intended to be encompassed by the following claims.

For example, fewer or more projectors may be used in the HUD system 100 to project fewer or more graphic elements. Further, while the HUD system 100 is described as having two projectors which project graphic elements in frontal focal planes and two projectors which project graphic elements in ground-parallel focal planes, the proportion of frontal and ground-parallel focal planes may be changed. The above-described vehicle functions associated with the HUD system 100 are exemplary, and may be changed or modified.

Further still, the mechanism by which the frontal focal planes are moved may be modified from that described above. For example, rather than moving the entire projector (e.g., the first and third projectors 118, 122 using the first and second actuators 156, 158), merely the diffuser screens (e.g., the diffuser screens 148, 152 of the first and third projectors 118, 122) may be moved relative to the respective projector units (e.g., the projector units 140, 144).

Additionally, while the HUD system 100 has been described with reference to the vehicle 106, which may be a four-wheeled automobile for outdoor use, the HUD system 100 may be used in different types of vehicles. For example, the HUD system may be provided in a marine vehicle (e.g., a boat), an air vehicle (e.g., an airplane or jet), or a vehicle intended for indoor use (e.g., a transportation cart, a vehicle used for material handling, such as a forklift, etc.).

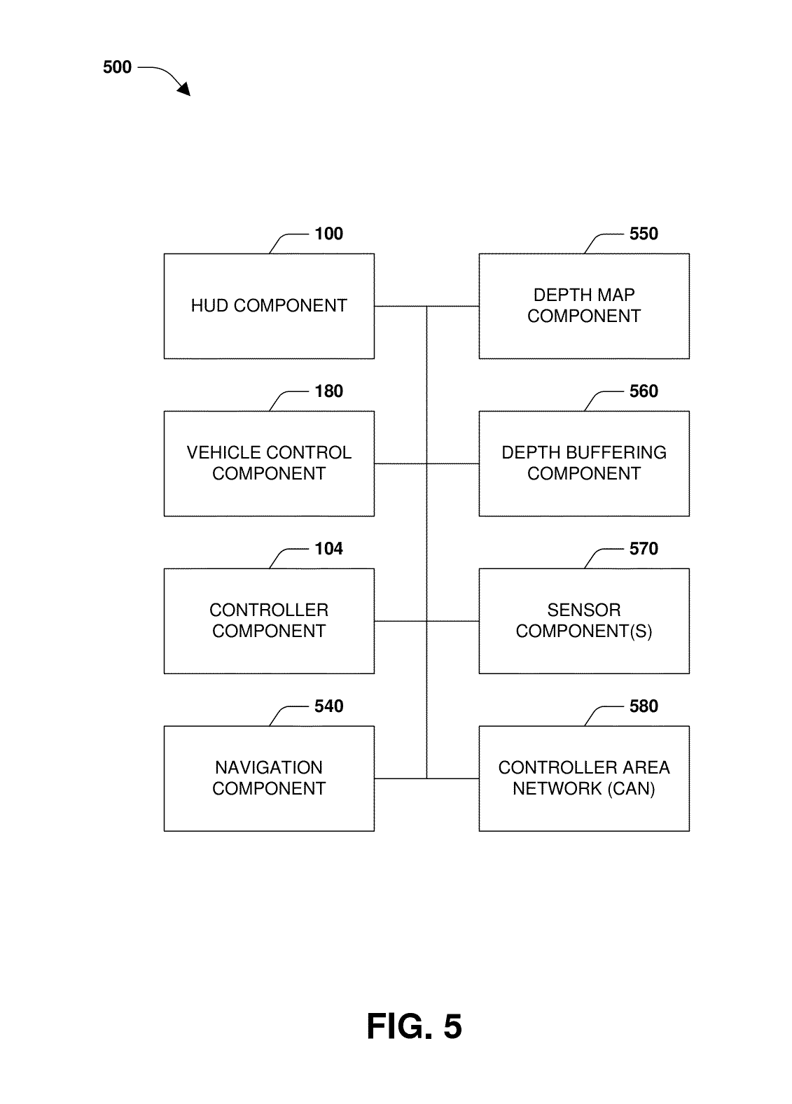

FIG. 5 is an illustration of an example component diagram of a system 500 for 3-D navigation, according to one or more embodiments. The system 500 can include a HUD component 100, a vehicle control component 180, a controller component 104, a navigation component 540, a depth map component 550, a depth buffering component 560, one or more sensor components 570, and one or more controller area networks (CANs) 580. The HUD component 100 can be a vehicular volumetric HUD system, such as the HUD system 100 of FIG. 1 and can include components described above. In one or more embodiments, the HUD component 100 can be a 3-D HUD, a variable distance HUD, an augmented reality HUD (AR-HUD), etc., among other things.

The navigation component 540 can be configured to receive or identify an origin location (e.g., point A) and one or more destination locations (e.g., point B). The navigation component 540 can be configured to calculate or determine one or more routes from point A to point B, for example. Generally, the navigation component 540 is associated with a vehicle. For example, the navigation component 540 may be mounted on the vehicle, integrated with one or more systems or one or more components of the vehicle, housed within the vehicle, linked or communicatively coupled with one or more components of the vehicle, or located within the vehicle, etc. In any event, the navigation component 540 can identify or receive the origin location and the destination location. In one or more embodiments, the navigation component 540 can include a telematics component (not shown) that may be configured to determine a current location or current position of the vehicle.

Additionally, the navigation component 540 can be configured to generate one or more routes from the origin location to one or more of the destination locations. In one or more embodiments, the navigation component 540 can be configured to generate one or more of the routes from a current location or current position of the vehicle to one or more of the destination locations. A route of the one or more routes can include one or more portions or one or more route portions. As an example, one or more portions of the route may include one or more navigation instructions or maneuvers associated with one or more road segments or one or more intersections of road segments. In other words, one or more portions of the route may include one or more turns, navigation maneuvers, road segments, intersections, landmarks, or other elements along the route. The navigation component 540 may be configured to identify one or more of these turns, navigation maneuvers, landmarks, etc. and issue one or more navigation commands or one or more navigation instructions accordingly, such as to a driver of the vehicle.

The navigation component 540 may issue one or more of the navigation commands or navigation instructions via an audio prompt, visual prompt, tactile prompt, etc. For example, the navigation component 540 may interface with one or more peripheral components (not shown) by transmitting one or more prompts across one or more controller area networks (CANs) 580. The navigation component 540 may play back an audible instruction, such as, “Turn left at Main Street”, or flash a light on the left hand portion of a display, vibrate the steering wheel, etc. to indicate to a driver that a driving action should be taken. The navigation component 540 can interact with one or more other components to facilitate transmittal or delivery of one or more of the driving instructions.

For example, the HUD component 100 may be configured to project one or more navigation instructions or one or more navigation maneuvers as one or more graphic elements or avatars in view of an occupant or driver of the vehicle. These navigation instructions may be received (e.g., directly or indirectly) from the navigation component 540. The HUD component 100 can be configured to project an avatar on successive focal planes such that the avatar appears to be moving to an occupant, such as a driver having a view from eye box 116 of FIG. 2. In this way, the HUD component 100 can enable a driver to perceive a volumetric image in view of the driver, where the volumetric image can serve as a ‘virtual’ guide vehicle for the driver of the vehicle to follow. In other words, it may appear to the driver of the vehicle that he or she is merely following a guide vehicle to a destination location, for example. Additionally, one or more other navigation commands or navigation instructions may be projected as a volumetric placeholder, marker, or flagpole, as will be described herein.

The HUD component 100 can be configured to project one or more graphic elements, which may be contact analog augmented reality graphic elements, conformal augmented reality graphic elements, avatars, icons, etc. These graphic elements can be projected by the HUD component 100 in a volumetric manner. As a result of this, one or more visual cues or one or more depth cues associated with the graphic elements can be substantially preserved. Preservation of one or more of these visual cues or depth cues may be achieved by projecting or rendering graphic elements on a dynamic focal plane or a movable focal plane. That is, the HUD component 100 may be configured to project or render one or more graphic elements on a movable or adjustable focal plane. A dynamic focal plane or a movable focal plane can be moved or adjusted along a path or a line, such as a line of sight of an occupant of a vehicle, as discussed with reference to FIG. 1 and FIG. 3, for example. In other words, the dynamic focal plane can be movable towards a vehicle or a windshield of a vehicle or away therefrom.

In one or more embodiments, a focal plane may be dynamic as a result of movement of projectors or screens of the HUD component 100, such as through the use of actuators, for example. That is, one or more projectors of the HUD component 100 can be configured to move in a linear fashion, thereby enabling respective projectors to project one or more graphic elements on a dynamic, movable, or adjustable focal plane, which move when the projectors move. In other embodiments one or more other means or alternative means for adjustments may be utilized.

Explained another way, when a graphic element is projected on a dynamic, movable, or adjustable focal plane, the graphic element may be projected onto a focal plane wherein a distance (e.g., distance 162′ or distance 170′ of FIG. 3) from the focal plane and the vehicle is being adjusted. Because projectors of a HUD component 100 can project or render graphic elements on movable focal planes, the focus of graphic elements projected at various distances from the vehicle can be adjusted. As mentioned, one or more of the focal planes may be oriented substantially perpendicular or substantially parallel to a line or sight of an occupant of the vehicle. In other words, a focal plane can be ground parallel or ground perpendicular. Additionally, one or more of the focal planes can be movable or static with respect to the line of sight of the occupant or the ground. This enables depth cues associated with the graphic elements to be correctly presented to occupants of the vehicle, such as the driver, as the vehicle moves or travels (e.g., and thus serves as a moving platform).

The HUD component 100 of FIG. 5 can be configured to project or render volumetric contact-analog augmented reality graphic elements. This means that these graphic elements may be projected to appear at various distances. In other words, the HUD component 100 can project graphic elements at multiple focal planes or in an adjustable manner. Explained yet another way, focal planes of graphic elements projected by the HUD component 100 can be adjusted to distances which extend beyond the windshield, such as next to a pedestrian on the sidewalk, thereby enabling an occupant to focus on the operating environment or driving environment, rather than switching focus of their eyes between the windshield or instrument panel of the vehicle and the driving environment. In this way, safety may be promoted by the system 500 for 3-D navigation.

Accordingly, graphic elements may be projected or visually placed (e.g., by the HUD component 100) in an environment in direct view of an occupant. This means that graphic elements can be rendered in the same space as the real environment, rather than on the windshield, allowing depth cues associated with the graphic element to be reproduced in an accurate or correct manner. As a result, graphic elements can be projected on the same focal planes as real world objects (e.g., the road) such that an occupant of a vehicle may view the graphic elements without looking away from the road, for example.

These multiple focal planes or adjustable focal planes may be achieved because when projectors of a HUD component 100 are moved, light rays can be reshaped or altered such that a graphic element or virtual object being projected can appear to be further away than the windshield or have a focal plane that is not on the windshield. That is, the projected graphic element or virtual object can have similar focal properties as a real object (e.g., pedestrian, vehicle, sign, etc.) that is far away (e.g., ten meters), for example. As light rays are reflected off of glass from the windshield, outgoing light rays diverge, thereby creating a ‘reflected’ image or a real image, which can be projected as a graphic element.

Because the light rays are reflected off of the windshield, rather than being emitted or appearing from the windshield (e.g., as with special coatings), re-rendering of a graphic element is not necessary when an occupant moves his or her head. For example, the continuous, static focal planes of FIG. 3 enable optically ‘correct’ or real images to be generated through the forward-rearward direction in 3-dimensional space (e.g., the direction of the line-of-sight of an occupant), thereby allowing proper motion parallax cues to be generated. Accordingly, when the occupant's head shifts, graphic elements associated with these focal planes may appear to be fixed in position in the environment, rather than moving around. As mentioned, this means that the HUD component 100 does not require head-tracking functionality to compensate for movement of an occupant's head.

The HUD component 100 can be rastor based, rather than vector based. This means that graphic elements projected by the HUD component 100 can be a bitmap, have a dot matrix structure, or be a rectangular grid of pixels. Additionally, the HUD component 100 can be configured to project one or more portions of one or more graphic elements with different shading, transparency levels, colors, brightness, etc.

In this way, the HUD component 100 can be configured to render or project graphic elements or avatars with various degrees of freedom. That is, accommodation may be preserved such that the eyes of an occupant may actively change optical power to focus on a graphic element projected on a focal plane. Similarly, vergence may be preserved such that the occupant may have concurrent inward rotation of a graphic element as the graphic element is projected to move ‘closer’ (e.g., by projecting onto successively closer focal planes).

In one or more embodiments, the HUD component 100 can project a graphic element as an avatar or a moving avatar for a driver or occupant of a vehicle to follow as a navigation instruction, maneuver, or command. For example, the HUD component 100 can be configured to project or render one or more of the graphic elements are a moving avatar, placeholder, identifier, flag pole, marker, etc. These graphic elements may be projected on one or more focal planes around an environment surrounding the vehicle, and projected in view of an occupant of the vehicle. An avatar or graphic element projected by the HUD component 100 can lead a driver of a vehicle through one or more portions of a route, and mitigate collisions with obstacles, obstructions, or road conditions by being projected to weave, navigate, move, or travel around the obstacles. A sensor component 570 can be configured to sense one or more obstacles or road conditions and a controller component 104 can direct the HUD component 100 to project the graphic element such that the graphic element travels around or bypasses a road condition, such as by changing lanes to avoid a traffic barrel, for example.

In one or more embodiments, the sensor component 570 can be configured to sense, identify, or detect one or more road conditions in an environment around or surrounding the vehicle. The sensor component 570 can detect or identify road segments, sidewalks, objects, pedestrians, other vehicles, obstructions, obstacles, debris, potholes, road surface conditions (e.g., ice, rain, sand, gravel, etc.), traffic conditions, traffic signs (e.g., red lights, speed limit signs, stop signs, railroad crossings, trains, etc.). These road conditions can be transmitted to the controller component 104 or the vehicle control component 180. For example, one or more of the CANs 580 may be used to facilitate communication between the sensor component 570 and the controller component 104 or the vehicle control component 180. In one or more embodiments, the sensor component 570 can include one or more image capture devices, a microphone, blind spot monitor, parking sensor, proximity sensor, presence sensor, infrared sensor, motion sensor, etc.

As used herein, a traffic condition may include an intersection, a vehicle, such as a vehicle sharing a roadway with a vehicle equipped with a 3-D navigation system, a railroad crossing, a red light, a road segment, a sidewalk, a stop sign, a yield sign, a traffic sign, a train, etc. As used herein, a road condition may include debris, gravel, potholes, a road surface condition, sand, fallen trees, spillage, oil slicks, weather conditions, such as ice or rain, etc. Further, an ‘object’ may include most any traffic conditions, road conditions, weather conditions, etc. Examples of objects may include but are not necessarily limited to other vehicles, stores, buildings, landmarks, obstacles in a roadway, road segments, intersections, pedestrians, etc. Objects may be found, detected, or be associated with a path, one or more road segments, etc. along a route on which a vehicle is travelling or is projected to travel along.

Explained in greater detail, the sensor component 570 may receive, sense, or detect information (e.g., objects, traffic conditions, road conditions, weather conditions, etc.) from an environment, such as a driving environment, an operating environment, or an environment surrounding a vehicle. Information collected by the sensor component 570 may be passed through the controller area network 580 and analyzed by the controller component 104 or over a telematics channel provided by the navigation component 540 and analyzed by a remote server (not shown). In any event, information received or collected by the sensor component 570 may be indicative of a reason for a driver to exercise caution, a reason to slow down (e.g., due to a speed limit posting or sign), a reason to speed up, a reason to stop, a reason to take a detour, etc. Explained another way, information collected by the sensor component 570 may be analyzed and translated by the controller component 104 or a remote server to one or more suggested driving actions for a driver. These suggested driving actions may be projected as visual cues or graphic element by the HUD component 100 based on information collected by the vehicle control component 180 and determinations made by the controller component 104.

In one or more embodiments, the sensor component 570 may sense or detect one or more objects, one or more traffic conditions, one or more road conditions, one or more weather conditions, etc. For example, a proximity sensor (e.g., one of the sensor components 570) on a vehicle may detect a pedestrian crossing a crosswalk. Additionally, other components may receive information relating to the environment, driving environment, or operating environment. For example, the vehicle control component 180 may receive similar information (e.g., via a telematics channel provided by the navigation component 540 or from the sensor component 570 over the controller area network 580). In this way, the vehicle control component 180 may aggregate information from one or more sources. In other words, the vehicle control component 180 may receive object information, traffic condition information, road condition information, weather condition information, etc.

The sensor component 570 may gather information directly from the environment, while the vehicle control component 180 may aggregate information from difference sources which may not necessarily be local to the vehicle. For example, the vehicle control component 180 may receive traffic information along a projected route for the vehicle from a traffic database or a news source. In any event, the vehicle control component 180 may aggregate information about the environment, such as the environment around a vehicle or environment information associated with a projected route for the vehicle (e.g., environment information at a location where a vehicle is anticipated to pass through while travelling along a predetermined route).

Regardless, the vehicle control component 180 can be configured to receive data associated with one or more of the road conditions or data related to an environment surrounding the vehicle (e.g., operating environment, driving environment, surrounding environment, etc.). In one or more embodiments, the vehicle control component 180 can receive one or more of the road conditions from the sensor component 570. Additionally, the vehicle control component 180 can receive one or more road conditions from one or more other sources, such as a server (not shown) or a database (not shown), for example. The vehicle control component 180 may be communicatively coupled with the server, third party, database, or other entity via a telematics channel initiated via a telematics component (not shown). In this way, the vehicle control component 180 can gather information associated with one or more portions of a route from an origin location to a destination location.

For example, the vehicle control component 180 may receive road condition information that includes traffic information of a road segment (e.g., whether traffic is congested, if there is an accident on the road, etc.). Additionally, the vehicle control component 180 may receive speed limit information associated with one or more of the road segments of a route. This information may be used to determine how to project one or more graphic elements to a driver or occupant of a vehicle. That is, if a road segment is associated with a 65 mph speed limit, and a current velocity (e.g., detected by the sensor component 570) of the vehicle is 25 mph, the vehicle control component 180 may command the HUD component 100 to project an avatar such that the avatar appears to speed up upon turning onto the road segment.

As another example, if the sensor component 570 detects a traffic barrel in a current lane in which the vehicle is travelling, the vehicle control component 180 can receive this information and make a determination that a navigation instruction to change lanes should be projected by the HUD component 100. This command may be transmitted over one or more CANs 580 to the HUD component 100, which can project, render, or animate an avatar or graphic element changing lanes or shifting position in response to the detected traffic barrel. In other words, the HUD component 100 may project an avatar or icon that appears to weave around or navigate around the traffic barrel, which is positioned in front of the vehicle in the operating environment surrounding the vehicle. As well, the vehicle control component 180 may be configured to have the HUD component 100 project a turn signal on the avatar, as a real vehicle might indicate when changing lanes. Further, the vehicle control component 180 may adjust a perceived velocity for the avatar as the avatar approaches the traffic barrel. This may be achieved by projecting the avatar or graphic element in successively closer focal planes or by adjusting a dynamic focal plane of the graphic element such that the distance between the dynamic focal plane and the vehicle or windshield of the vehicle is reduced. (Conversely, when it is desired to project the avatar as speeding up, the dynamic focal plane may be adjusted such that the distance between the dynamic focal plane and the vehicle or windshield thereof is increased).

In other words, the vehicle control component 180 can be configured to receive one or more road conditions, wherein a road condition of the one or more road conditions includes traffic information of one or more of the road segments or speed limit information associated with one or more of the road segments. Further, the vehicle control component 180 can be configured to drive the HUD component 100 to project one or more graphic elements based on one or more of the road conditions, such as a speed limit of a road segment, and a current velocity of the vehicle. In this way, the vehicle control system 180 can determine one or more appropriate actions (e.g., stop, speed up, change lanes, slow down, etc.) or navigation instructions to be projected by the HUD component 100.

In one or more embodiments, the system 500 can include a view management component (not shown) that manages one or more aspects of one or more graphic elements projected by the HUD component 100. In one or more embodiments, the controller component 104 can be configured to manage one or more of these aspects or functionality associated with the vehicle control component 180. For example, the controller component 104 can be configured to receive one or more road conditions.

The controller component 104 may be configured to determine a type of graphic element to be displayed, projected, animated, rendered, etc. by the HUD component 100. As an example, when a vehicle is travelling along one or more portions of a route that include relatively straight road segments, the controller component 104 may project a graphic element to be an avatar. The avatar may appear or be projected as a vehicle or a guide vehicle. In a scenario where a vehicle is travelling along one or more portions of a route that include one or more turns or other navigation maneuvers, the controller component 104 may command the HUD component 100 project a graphic element to be a marker at a location associated with one or more of the turns. For example, if a route includes a right turn from a first street onto a second street, the controller component 104 may command the HUD component 100 to project a marker or identifier at, to, around, etc. the intersection of the first street and the second street. In this way, the controller component 104 may be configured to determine one or more types (e.g., markers, identifiers, flag poles, guide avatars, etc.) of graphic elements to be displayed.

Additionally, the controller component 104 can be configured to determine one or more locations where a graphic element will be projected. In other words, the controller component 104 can decide when and where a graphic element will be projected or how the graphic element will be displayed. A location of a graphic element can include a focal plane, a distance of the focal plane from the vehicle or windshield thereof, x-coordinates, y-coordinates, z-coordinates, etc. along an x, y, or z axis, for example. This location may be called a target position for one or more of the graphic elements. In one or more embodiments, the controller component 104 can be configured to adjust a distance between one or more of the focal planes of one or more of the graphic elements and the vehicle (e.g., or windshield of the vehicle) based on one or more road conditions associated with one or more portions of the route, a current position of the vehicle, a current velocity of the vehicle, etc.

That is, if a road segment (e.g., portion of a route where a vehicle is currently located or positioned) is associated with a 65 mph speed limit (e.g., a road condition), and a current velocity (e.g., detected by the sensor component 570) of the vehicle is 25 mph (e.g., current velocity of the vehicle), the controller component 104 can be configured to command the HUD component 100 to project an avatar or graphic element which appears to be travelling at about 65 mph. In one or more embodiments, the avatar may be projected in a manner which demonstrates gradual acceleration from 25 mph to 65 mph. This means that a distance between the focal plane of the avatar and the vehicle may be adjusted accordingly. For example, in a scenario where the vehicle accelerates at approximately the same pace, the distance between the focal plane and the vehicle may remain about the same. If the vehicle accelerates at a slower pace than the avatar, that distance between the focal plane and the vehicle may be adjusted to increase by the controller component 104. In any event, this adjustment may be based on a current position of the vehicle or a current velocity of the vehicle, as well as road conditions of the route associated therewith.

Additionally, the controller component 104 may be configured to adjust or determine a size of a graphic element according to or based on a distance of the focal plane of the graphic element and the vehicle with the HUD component 100. This means that the controller component 104 can adjust a height, size, width, depth, etc. of a graphic element, guide icon, or avatar based on a desired perception. For example, to make an avatar appear to speed up, the controller component 104 may adjust the size of the avatar to shrink or be reduced while projecting the avatar onto successively farther focal planes or adjusting a dynamic focal plane to be farther and farther away from the vehicle.

In one or more embodiments, the size of the graphic element may be utilized as an indicator for an importance level of a navigation instruction or message. In other words, the more important the message or navigation instruction, the bigger the avatar, icon, or graphic element will be projected.

The controller component 104 can be configured to determine one or more actions for one or more of the graphic elements to be projected by the HUD component 100. For example, the controller component 104 may command the HUD component 100 to project an avatar to speed up, slow down, stop, change lanes, activate a turn signal prior to changing lanes, flash, blink, change an orientation or angle of an avatar, change a color of an avatar, etc. Further, the controller component 104 may adjust target positions for one or more of the graphic elements based on road conditions, a current position of the vehicle, a current velocity of the vehicle, or other attributes, characteristics, or measurements. In one or more embodiments, the controller component 104 can interface or communicate with the navigation component 540 across one or more CANs 580.

The controller component 104 may be configured to mitigate obstructions, distractions, or other aspects which may impede a driver or occupant of a vehicle. In one or more embodiments, the controller component 104 can be configured to receive a location of the horizon, such as from sensor component 570, and project graphic elements above the horizon or sky plane, etc. The controller component may be configured to determine or adjust a color, transparency, or shading of one or more graphic elements based on a time of day, traffic levels associated with the route, a familiarity the driver has with the route, etc.

The depth map component 550 can be configured to build or receive a depth map of an environment around or surrounding the vehicle, such as an operating environment. The HUD component 100 can utilize the depth map to project one or more graphic elements accordingly. This means that if an avatar turns a corner and is ‘behind’ a building (e.g., a building is between the line of sight of an occupant of the vehicle and a perceived or target location of the graphic element or avatar), the HUD component 100 can enable or disable projection of one or more portions of the avatar or graphic elements in line with what should be seen.

The depth map component 550 may be configured to receive a depth map from a server or third party server. For example, the depth map component 550 can download a depth map from a server via a telematics channel initiated via a telematics component (not shown). In other embodiments, the sensor component 570 can be configured to detect depth information which can be used to build the depth map by the depth map component 550. That is, the depth map component 550 can interface or communicate with one or more sensors to build the depth map or receive a pre-built depth map from a database. In any event, the depth map component 550 can build or receive a depth map based on depth information. The depth map can be indicative of distances of one or more surfaces, objects, obstructions, geometries, etc. in the environment or area around the vehicle.

The depth map may be passed or transmitted to the controller component 104, which can command the HUD component 100 to render one or more of the graphic elements accordingly. For example, the HUD component 100 can project or render graphic elements based on a height of an eye box associated with an occupant of a vehicle, a location of the vehicle, and a depth map of the area, which may be actively sensed or received from a database. The HUD component 100 can thus project one or more of the graphic elements based on the depth map to account for a perspective of one or more occupants of the vehicle.

The depth buffering component 560 can be configured to facilitate perspective management for one or more occupants of the vehicle utilizing the depth map generated or receive by the depth map component 550. That is, the depth buffering component can be configured to facilitate rendering of graphic elements such that the graphic elements appear visually ‘correct’ to an occupant. For example, if a graphic element is to be projected behind a real world object, the depth buffering component 560 can ‘hide’ a portion of the graphic element from an occupant by not projecting or rendering that portion of the graphic element. In other words, the depth buffering component 560 can manage which portions (e.g., pixels) of a graphic element are drawn, projected, or rendered, and which portions are not. To this end, the depth buffering component 560 can be configured to enable or disable rendering of one or more portions of one or more of the graphic elements based on the depth map.

Additionally, the depth buffering component 560 can be configured to obscure real world objects, thereby inhibiting what an occupant of a vehicle may see. For example, the depth buffering component 560 may command the HUD component 100 to project a white graphic element such that the graphic element overlays a real world object, such as a billboard (e.g., detected by sensor component 570). As a result, an occupant may not see the billboard or have an obscured view of the billboard. In this way, the depth buffering component can be configured to mitigate distractions for a driver or an occupant of a vehicle by providing graphic elements that facilitate diminished reality.

Examples of navigation instructions that can be projected by the HUD component 100 include following a guide vehicle, speeding up (e.g., changing a dynamic focal plane to have an increased distance from the focal plane to the vehicle, thereby adjusting a near-far perception a driver or occupant may have of the graphic element), slowing down (e.g., adjusting the distance between a focal plane and the vehicle to be reduced), changing lanes (e.g., adjusting a target position for a graphic element), navigating around obstructions, turning, arrival, marking a location, etc. As an example, the controller component 104 may command the HUD component 100 to project an avatar to ‘slow down’ if a pedestrian steps out onto the road segment, road way, crosswalk, etc. As another example, the controller 104 may command the HUD component 100 to project deceleration based on an angle of a turn, a speed limit associated with a road segment, road conditions, such as ice, etc. That is, if there is ice on the road surface, the controller 104 may command the HUD component 100 to project an avatar moving slower than if no ice were present on the road surface.

In one or more embodiments, the controller component 100 can mark or identify an upcoming turn or intersection with a marker, flag post, flag pole, identifier, etc. For example, the HUD component 100 can render or project a placeholder or marker according to the perspective of the occupant of the vehicle. The depth map component 550 may be configured to provide a depth map such that real life objects, such as buildings, trees, etc. act as line of sight blockers for one or more portions of the placeholder. As an example, if a placeholder has a perceived height of 100 feet, and a 50 foot tall building is in front of the placeholder, the depth buffering component 560 may compensate for the line of sight blocking by disabling rendering or projection of a bottom portion of the placeholder graphic element, thereby rendering the placeholder according to the perspective of the driver or occupant.

In one or more embodiments, one or more of the graphic elements are projected in view of an occupant of the vehicle based on the route (e.g., a follow a guide vehicle mode). In one or more embodiments, graphic element can be projected as an avatar or other guide icon. The avatar may appear to be flying and be displayed against a real world environment around the vehicle. The avatar can move, travel, or ‘fly’ in 3-D space or in three dimensions. Because of this, the avatar or graphic element may appear to move in 3-D, thereby providing a more intuitive feel or secure feeling for an occupant or driver following the avatar. As an example, an avatar, graphic element, or guide icon may be projected such that it appears to change in height or size based on a perceived distance from an occupant of the vehicle. The avatar may be animated by sequentially projecting the moving avatar on one or more different focal planes. Additionally, the avatar could appear to navigate around obstructions, obstacles, pedestrians, debris, potholes, etc. as a real vehicle would. In one or more embodiments, the avatar could ‘drive’, move, appear to move, etc. according to real-time traffic. The avatar may change lanes in a manner such that the avatar does not appear to ‘hit’ another vehicle or otherwise interfere with traffic. As another example, if a route takes a driver or a vehicle across train tracks, the avatar may stop at the train tracks when a train is crossing. In other embodiments, the HUD component 100 can be configured to project the avatar or graphic element to stop at stop signs, red lights, or obey traffic laws. Upon arrival at a destination location, the HUD component 100 can be configured to render or project an avatar in a resting pose, for example.

In this way, the system 500 for 3-D navigation can generate an intuitive message, instruction, or command for an occupant of a vehicle, such as a driver. The instruction can be based on one or more aspects related to perspective, as provided by the ability of the HUD component to project or render volumetric, 3-D graphic elements along one or more adjustable focal planes. For example, the 3-D effect can be determined based on distance, perspective, perceived distance, road conditions, etc.

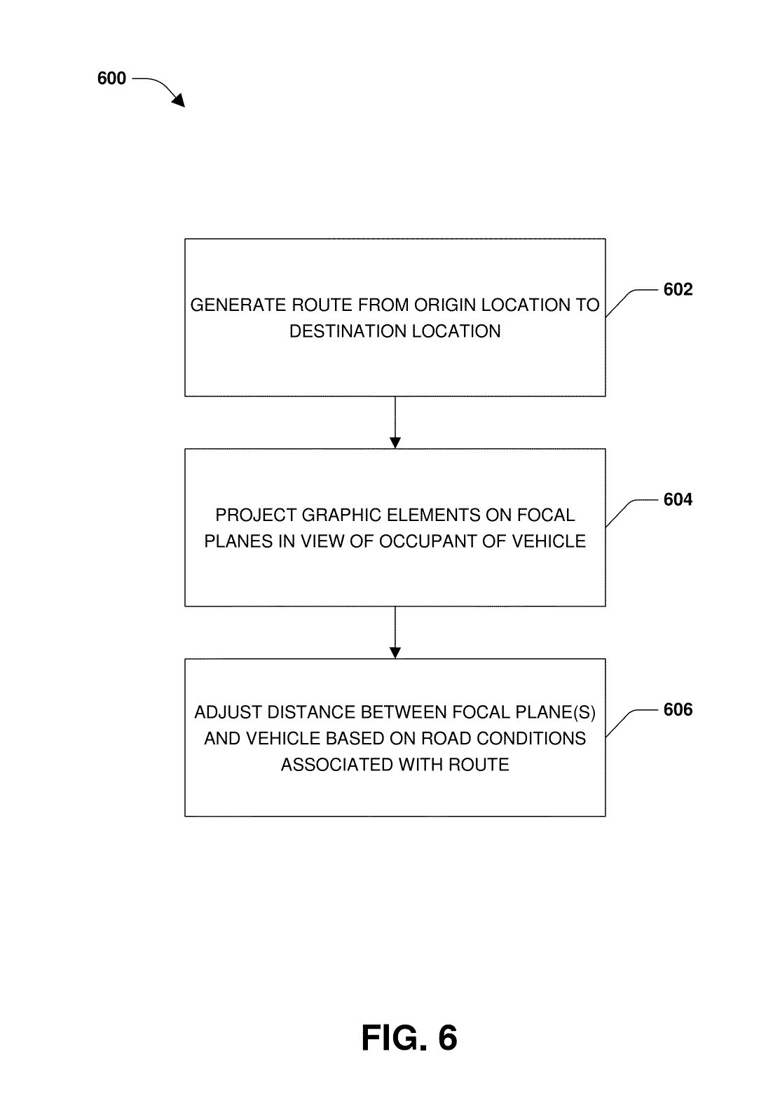

FIG. 6 is an illustration of an example flow diagram of a method 600 for 3-D navigation, according to one or more embodiments. At 602, a route can be generated from an origin location to a destination location. In one or more embodiments, the origin location or the destination location can be received via a telematics channel, such as from a global positioning system (GPS) unit. At 604, one or more graphic elements can be projected on one or more focal planes in view of an occupant of a vehicle. Here, graphic elements may be displayed as avatars, images, icons, identifiers, markers, etc. Additionally, these graphic elements can be based on one or more portions of the route. This means that these graphic elements may be projected at various distances depending on the portion of the route at which a vehicle may be located (e.g., a current position of the vehicle).

At 606, a distance between a focal plane and the vehicle may be adjusted based on road conditions associated with one or more portions of the route. Further, the distance may also be adjusted based on a current velocity of the vehicle. For example, if a vehicle traveling along a portion of a route associated with a 65 mile per hour (mph) speed limit and the current velocity of the vehicle is 25 mph, the distance of between the focal plane of a projected graphic element or avatar may be increased (e.g., to indicate to the driver or occupant to speed up). In other words, the graphic element may be projected to appear as if it were travelling about 65 mph, thereby prompting the occupant or driver to speed up and ‘catch’ the avatar (e.g., similar or simulating following a guide vehicle).

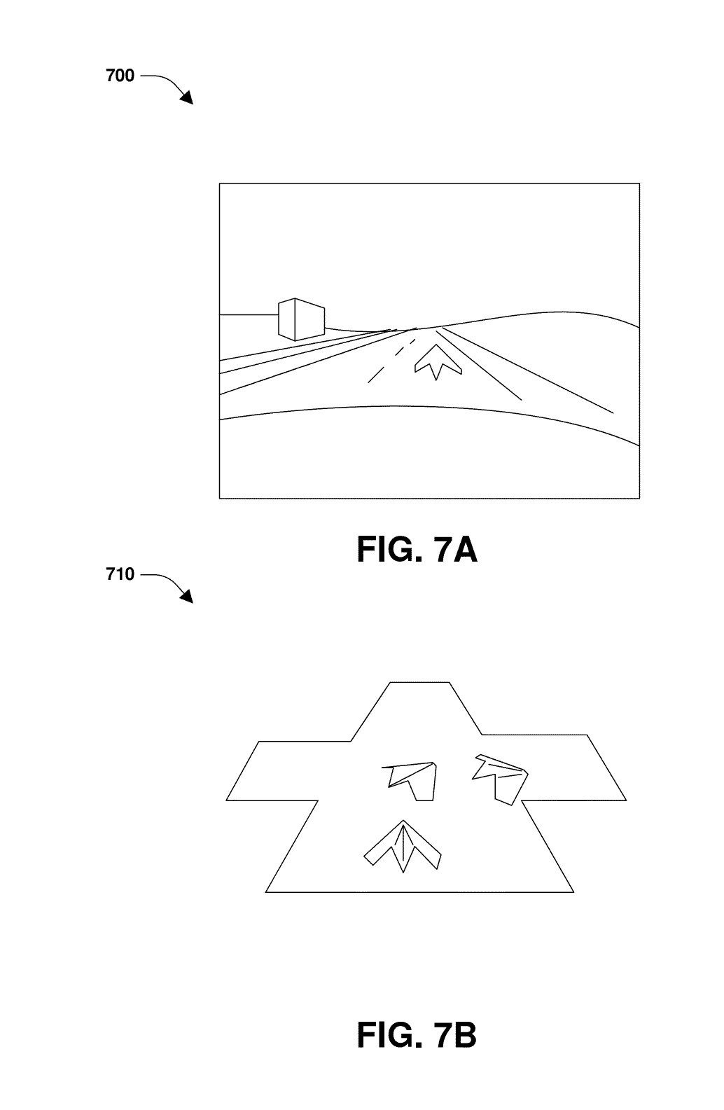

FIG. 7A is an illustration of an example avatar 700 for 3-D navigation, according to one or more embodiments. The avatar 700 of FIG. 7A may appear in front of a vehicle and fly, glide, move, maneuver, etc. around elements, obstructions, traffic, road conditions, etc. FIG. 7B is an illustration of an example avatar(s) 710 for 3-D navigation, according to one or more embodiments. The avatar(s) 710 of FIG. 7B are seen from an elevated view, such as a birds-eye view slightly behind the avatars(s) 710. It can be seen that one or more of the avatars 710 are projected on one or more different focal planes or target positions, thereby providing the perception that a driver or occupant is following a real vehicle.

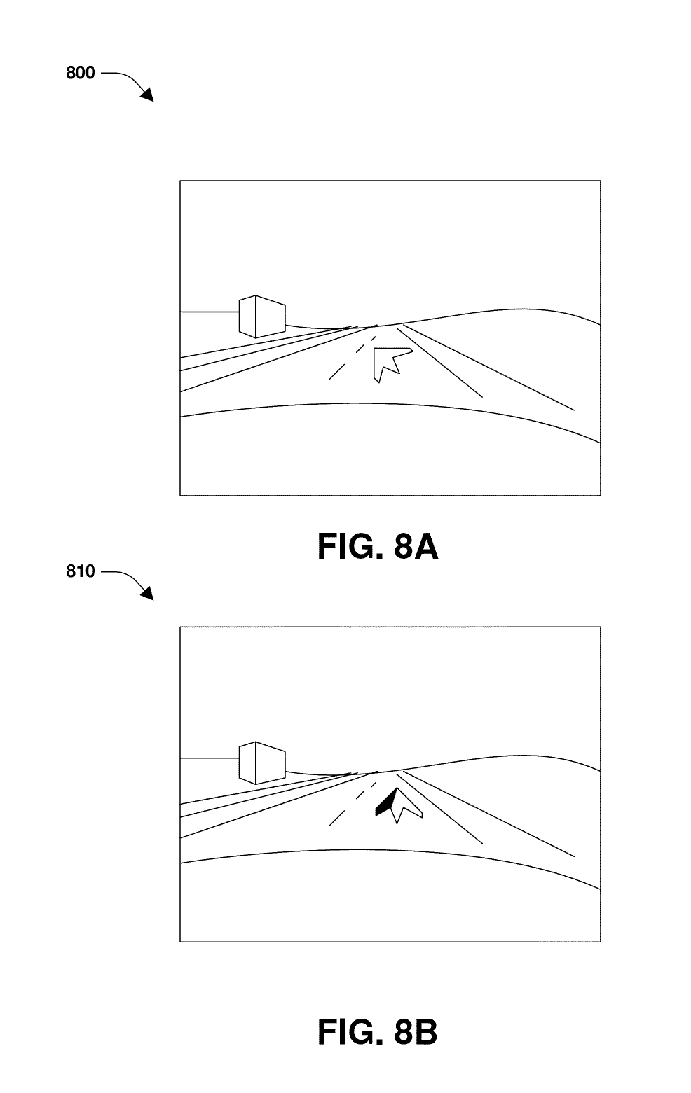

FIG. 8A is an illustration of an example avatar 800 for 3-D navigation, according to one or more embodiments. The avatar 800 of FIG. 8A is rotated counterclockwise to indicate a left turn. FIG. 8B is an illustration of an example avatar 810 for 3-D navigation, according to one or more embodiments. In one or more embodiments, the avatar 810 of FIG. 8B can indicate a left turn by blinking, flashing, changing color, etc. For example, the left wing of the paper airplane avatar 810 may glow or change in intensity to indicate the upcoming left turn. In one or more embodiments, an avatar may be projected on focal planes closer to the vehicle such that it appears that the avatar is ‘slowing down’prior to making a turn.

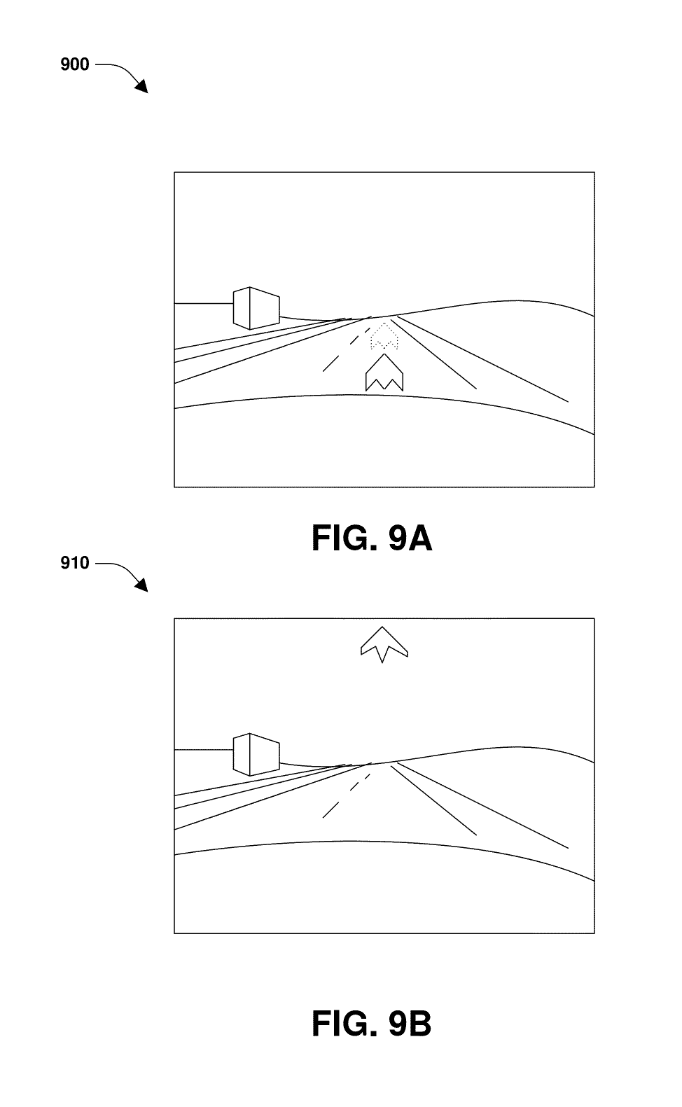

FIG. 9A is an illustration of an example avatar 900 for 3-D navigation, according to one or more embodiments. FIG. 9B is an illustration of an example avatar 910 for 3-D navigation, according to one or more embodiments. The avatar 900 of FIG. 9A can be projected as a navigation instruction for a driver of a vehicle to slow down, for example. In FIG. 9B, the avatar 910 is projected above the horizon or a sky plane such that the avatar 910 does not obstruct the driver or occupant from viewing one or more portions of the environment around the vehicle.

FIG. 10-FIG. 20 are described with reference to one or more of the previous figures, such as the system 500 for 3-D navigation of FIG. 5 or the side view 300 or focal planes of FIG. 3.

FIG. 10A is an illustration of an example scenario 1000 associated with 3-D navigation, according to one or more embodiments. In FIG. 10A, an occupant, driver, passenger, operator, etc. of a vehicle may provide a command to one or more components of the vehicle, such as the sensor component 570 of FIG. 5. In one or more embodiments, the sensor component 570 may include one or more peripheral components, one or more peripherals, one or more interfaces, one or more interface components, such as a touch screen, a keyboard, one or more buttons, an interface, a microphone, one or more image capture devices, gesture recognition device, etc. For example, a vehicle may be equipped with a touch screen interface or buttons on a dash may be utilized to interface with a menu. In any event, one or more components or the sensor component 570 may capture or receive commands given or provided by an occupant of a vehicle.

For example, a driver may speak navigation commands to the vehicle, such as “How do I get to downtown Sunnyvale?” In this example, the sensor component 570 includes a microphone which receives the verbal or spoken request from the occupant or driver and passes the request through a controller area network 580 to a controller component 104 or a navigation component 540. In other embodiments, if a mobile device is communicatively coupled with a vehicle, an occupant may utilize a microphone of the mobile device, a touch screen of the mobile device, a keyboard or keypad of the mobile device, etc. to interface with the system 500 for 3-D navigation. The controller component 104 may perform voice recognition on the request by utilizing an on-board speech recognition module to convert the request from speech to text (STT). As another possibility, the navigation component 540 may utilize a telematics channel to communicate with a remote server where STT processing may be done.

In one or more embodiments, the HUD component, such as the HUD component or system 100 of FIG. 1 or the HUD component 100 of FIG. 5, may project, present, render, or display confirmation of a request or a command. In other words, the HUD component 100 may act as a display component or supplement other display components for a vehicle. Continuing with the “How do I get to downtown Sunnyvale?” example in FIG. 10A, when a command or a request is received by the controller component 104, the controller component 104 may determine whether or not to project confirmation of the request based on environment information provided or detected by the sensor component 570. Here, because the sensor component 570 does not detect moving vehicles, pedestrians, or other obstacles, the controller component 104 may make a determination that a confirmation of the request should be projected by the HUD component 100. Additionally, the controller component 104 may determine a size, a shape, a model, a transparency, a color scheme, a height, a width, a depth, a target position, a focal plane, etc. for a corresponding graphic element. To this end, a confirmation of the request may be projected by the HUD component 100 in a text box, as seen at 1004.

In one or more embodiments, the controller 104 may command the HUD component 100 to project a graphic element as an avatar 1002, which may appear as a guide icon. In FIG. 10A, the graphic element may be projected as an avatar 1002 having a shape or appearance of an airplane, which glides along a route slightly ahead of a driver or occupant of the vehicle. To facilitate awareness, the controller component 104 may have the HUD component 100 animate the avatar 1002 such that the avatar 1002 hovers or is constantly in motion. In other words, to make the avatar 1002 easier to see, the controller component 104 may have the HUD component 100 associate the avatar 1002 with motion on a periodic basis. For example, the HUD component 100 may project the avatar 1002 to appear as if it is floating in water, bobbing, hovering, etc. In this way, driver awareness may be increased.

FIG. 10B is an illustration of an example scenario 1010 associated with 3-D navigation, according to one or more embodiments. When a request or a command, such as a navigation command, is received by the controller component 104, the controller component 104 may forward the request or command to the appropriate component or module. In this example, the controller component 104 may identify the request or command as a navigation command and pass the navigation command along to the navigation component 540. Accordingly, the navigation component 540 may determine an origin location for the vehicle (e.g., a current location), the destination location, and calculate a route from the origin location to the destination location. As discussed herein, the route may include one or more route portions along one or more road segments and/or one or more navigation actions or maneuvers.

The navigation component 540 may provide the route, route portions, or route information to the controller component 104, which may determine whether or not and/or how to render the route information. For example, because the vehicle is not in motion (e.g., in park) or travelling at a low velocity (e.g., below a velocity threshold detected or provided across the controller area network 580) in FIG. 10B, the controller component 104 may determine that a high-level view 1030 of the route may be appropriate for the HUD component 100 to project. Accordingly, the controller component 104 may have the HUD component project the high-level view 1030 such that the view 1030 occupies a larger area within the environment. In other words, the controller may determine a size for a graphic element or whether or not to project the graphic element based on a velocity of the vehicle. Conversely, if the vehicle is in motion or travelling above a threshold velocity, the controller component 104 may make a determination that a smaller version be projected or that the HUD component 100 not project the high-level view 1030 at that time.

In FIG. 10B, the HUD component 100 may project a high-level view 1030 of a map which includes a route 1032 from an origin location to a destination location along one or more road segments. The HUD component 100 may project a compass 1034, road segment identifiers 1036, traffic information, estimated arrival times, estimated travel times, a current location of the vehicle, etc. In one or more embodiments, the HUD component 100 may project different aspects of the high-level view 1030 utilizing one or more color schemes. For example, the HUD component 100 may project the route such that the route 1032 is rendered utilizing a first color and other road segments, such as the road segment identified at 1036, are rendered utilizing a second color.

In one or more embodiments, the sensor component 570 may include image capture devices or other sensors which aid in determination of a color palette or color scheme for display or projection of graphical elements. For example, in FIG. 10B, it may be seen that there are one or more trees in the background or in the environment, which may make green more difficult to see or visualize. Accordingly, the controller component 104 may select a color scheme for projection of one or more graphical elements which utilizes colors which contrast green, such as yellow, for example. As another example, during the daytime, the sky may be sensed to be blue by the sensor component 570, while at night the sky may appear black. In other words, the sensor component 570 may receive, capture, sense, or detect color information associated with the environment, which may be utilized for contrast of graphic elements. The controller component 104 may utilize this information to determine colors for which the HUD component 100 may project one or more graphic elements. Here, the controller component 104 may determine that red is an option during the daytime while blue is an option at nighttime. In this way, the controller component may determine color schemes or a color for a graphic element or avatar based on a time of day or color information associated with the environment (e.g., received or detected by the sensor component 570).

In one or more embodiments, the HUD component 100 may animate one or more aspects of the high-level view 1030. For example, the HUD component 100 may animate the route 1032 along one or more road segments such that or as if the route 1032 was being drawn from the origin location to the destination location with one continuous pen stroke. In other words, the HUD component 100 may render animation representing travel along the route in a snake-like fashion from the origin location to the destination location.

The HUD component 100 may project graphic elements or avatars, such as the avatar 1002 of FIG. 10A using different camera angles, camera perspectives, or different views. Further, the HUD component 100 may shift or transition between these views in an animated or gradual fashion. For example, the HUD component 100 may shift the camera perspective or the camera angle from a birds-eye-view, such as the high-level view 1030 of FIG. 10B to a first-person view or third person view, as seen in FIG. 10A. Explained, another way, the HUD component 100 may gradually adjust the camera perspective to zoom in or fly in from a birds-eye-view, layout view, overhead view, zoomed-out view, or third-person view to a zoomed-in view, first-person view, street-level view, etc.

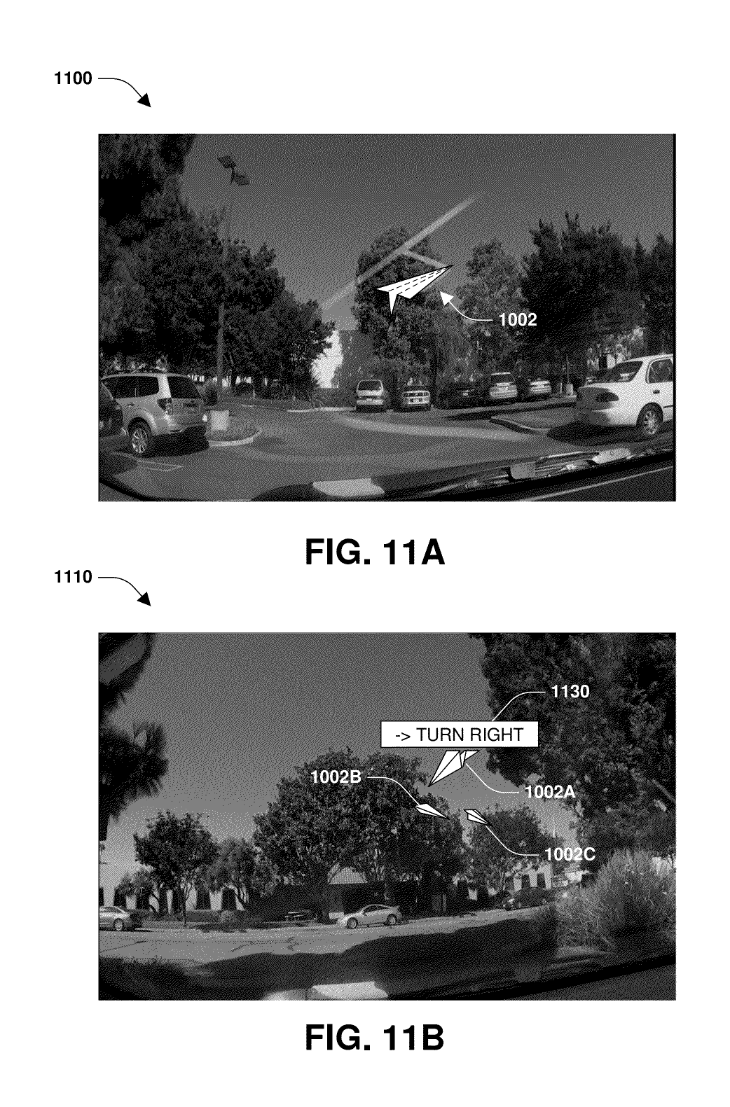

For example, the HUD component 100 may utilize a camera perspective or a camera angle which appears to finish zooming or transitioning at a street-level view which coincides with the real world view or the same view of the environment which an occupant or driver would have sitting in his or her vehicle looking out through the windshield into the real world. In other words, the street-level view may be a view an occupant has while within an eye box and facing/looking in a forward direction through a windshield of the vehicle. Explained another way, the zoom animation or transition may result in a rendering of merely an avatar or graphic element in view of the driver, such as the avatar 1002 of FIG. 10A. FIG. 11A is an illustration of an example scenario 1100 associated with 3-D navigation, according to one or more embodiments. It may be seen that the view of the avatar 1002 provided in this example scenario 1100 is a transitional view achieved between the bird-eye view or high-level view 1030 of FIG. 10B and the third-person view in FIG. 10A.

In one or more embodiments, the HUD component 100 may provide a zoom animation in reverse order (e.g., from third-person view to birds-eye-view) when an occupant request a view of a map or when the occupant initiates a map view command. In this scenario, the HUD component 100 may project a third-person view of an avatar (e.g., 1002 of FIG. 10A) and zoom out or fly away to a bird-eye-view (e.g., high-level view 1030 of FIG. 10B). Further, the HUD component 100 may adjust an orientation of the route, map, or view based on a direction or bearing of the vehicle. In other words, the HUD component 100 may orient the map or view such that the direction of travel along a current road segment appears to be up or forward, for example.

FIG. 11B is an illustration of an example scenario 1110 associated with 3-D navigation, according to one or more embodiments. In one or more embodiments, the HUD component 100 may provide navigation instructions or suggested navigation maneuvers to a driver of a vehicle. For example, the navigation component 540 may generate a list of navigation instructions for a route from an origin location to a destination location. The controller component 104 may have the HUD component 100 project respective navigation instructions in the environment, such as at 1130, for example. Navigation instructions may include directions for a driver, such as turn right, turn left, merge right, merge left, yield, stop, slow down, speed up, accelerate, etc. Further, navigation instructions may not necessarily direct a driver to take action. For example, navigation instructions may alert a driver of a vehicle that no turns on red are permitted.

In one or more embodiments, the controller component 104 may utilize a color scheme or have the HUD component 100 project one or more of the graphic elements or avatars utilizing different colors to represent one or more navigation actions. For example, when the HUD component 100 projects an avatar, such as avatar 1002A, 1002B, or 1002C of FIG. 11B as green, this may be indicative that no objects, obstacles, or oncoming traffic are detected by the sensor component 570. As another example, the HUD component 100 may project one or more of the avatars 1002A, 1002B, or 1002C as red to indicate to the driver that it is not yet safe to make the turn. Here, the HUD component 100 may project a “yield” as a navigation instruction rather than “turn right”, for example.

As seen in FIG. 11B, the HUD component 100 may project multiple avatars 1002A, 1002B, and 1002C. In this example, avatar 1002A may be projected on a first focal plane, avatar 1002B may be projected on a second focal plane, and avatar 1002C may be projected on a third focal plane, where the first focal plane is closest to the vehicle, followed by the second focal plane, then the third focal plane, thereby giving the appearance that avatar 1002C is the farthest away from the vehicle. Because the HUD component 100 is capable of projecting multiple avatars 1002A, 1002B, and 1002C on different focal planes, this enables the system 500 for 3-D navigation to provide a projected route, path, or predetermined route for a driver to follow.

In one or more embodiments, the HUD component 100 may project one or more of the avatars 1002A, 1002B, or 1002C such that respective avatars maintain focal planes which are static relative to the current position of the vehicle. In other words, the HUD component 100 may project avatars or graphic elements such that the distance between the vehicle and focal planes for respective avatars decreases as the vehicle ‘approaches’ an avatar. Stated yet another way, the HUD component 100 may project an avatar, such as one of 1002A, 1002B, or 1002C as a stationary object relative to the vehicle, thereby making it appear to a driver or occupant that an avatar ahead of the vehicle at one time is being passed or waits for the vehicle to ‘catch-up’ at a later time. In these embodiments, the HUD component 100 may project additional avatars as a route progresses and an individual or driver of a vehicle ‘passes’ the stationary or static avatars.

In one or more other embodiments, the HUD component 100 may project one or more of the avatars 1002A, 1002B, or 1002C such that respective avatars have focal planes which are dynamically adjusted as to the current position of the vehicle or have a constant or fixed distance from the vehicle. In other words, the HUD component may project avatars or graphic elements such that the distance between the vehicle and focal planes for respective avatars remains constant as the vehicle moves. Stated yet another way, the HUD component may project avatars as stationary objects which appear to move along with the vehicle. In one or more embodiments, the HUD component 100 may transition between projecting avatars as stationary objects relative to the vehicle and projecting avatars as objects which appear to move with the vehicle.

In any event, the HUD component 100 may project any one of a plurality of graphic elements or avatars as an animation by adjusting focal planes on which to project one or more of the graphic elements or avatars. As an example, positioning of avatars 1002A, 1002B, and 1002C may be achieved by expanding a single avatar, such as the avatar 1002 of FIG. 11A or FIG. 10A. In other words, one or more avatars (or graphic elements) may be expanded from a first avatar and respective avatars may be collapsed into a single avatar. Explained another way, multiple avatars may fly-out, separate, advance, or be projected ahead of a first avatar by the HUD component 100 to facilitate animating of route navigation or navigation instructions, for example.

In one or more embodiments, the HUD component 100 may project one or more graphic elements as pointers which may alert a driver or an occupant of a vehicle of one or more objects, obstacles, road conditions, etc. The controller component 104 may select a pointer type based on a velocity of the vehicle and a velocity of an object. For example, if the vehicle is stationary, oncoming traffic (e.g., or other objects) may be identified by projecting a graphic element which rotates in a manner which points to the traffic, hazard, or moving object while the object approaches the vehicle or departs away from the vehicle.

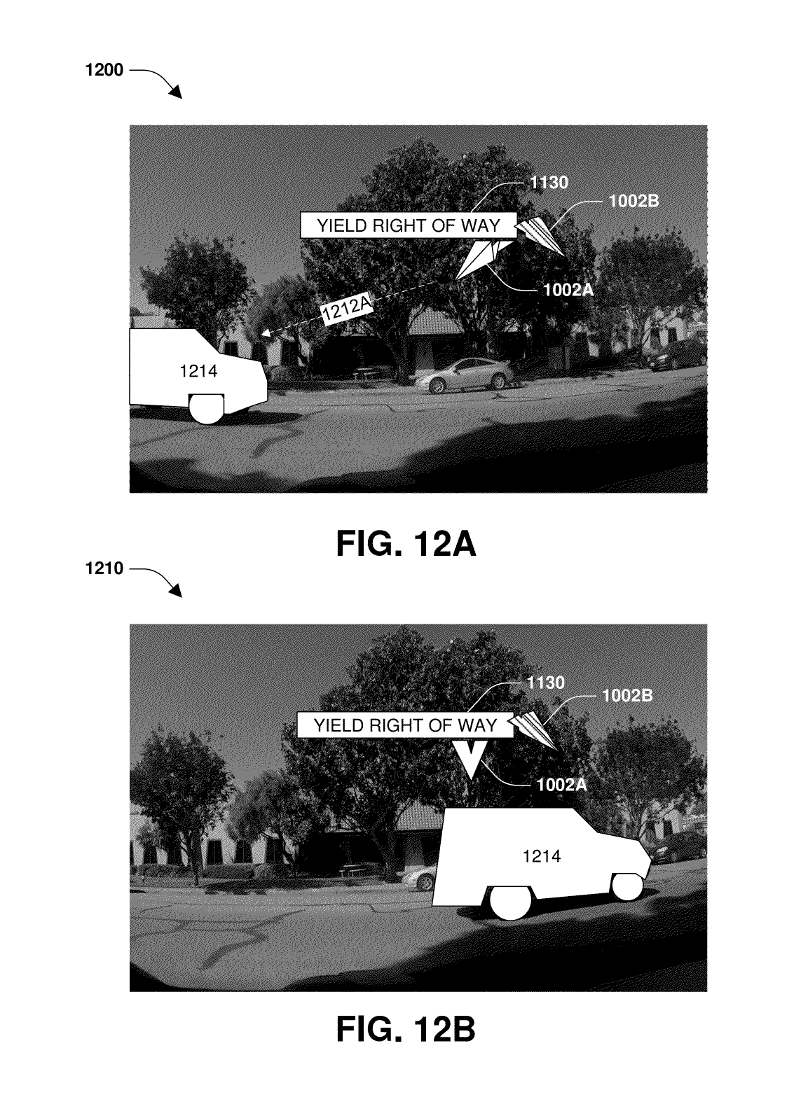

FIG. 12A is an illustration of an example scenario 1200 associated with 3-D navigation, according to one or more embodiments. Here, the sensor component 570 may detect passing traffic or another vehicle 1214. Because the trajectory or path of the other vehicle 1214 is on a collision course with the suggested navigation action indicated by avatar 1002B, the controller component 104 may have the HUD component 100 project navigation instructions which alert the driver that he or she should yield at 1130. In other words, the sensor component 570 may track the location of the other vehicle 1214. This information may be transmitted to the controller component 104, which may determine that pointer graphic element should be projected by the HUD component 100 at 1002A. The HUD component 100 may thus project the pointer graphic element 1002A such that it tracks or follows 1212A the other vehicle 1214.

FIG. 12B is an illustration of an example scenario 1210 associated with 3-D navigation, according to one or more embodiments. Continuing with the example from FIG. 12A, it may be seen that the other vehicle 1214 has passed the vehicle, which was stationary. The HUD component 100 may continue to project the yield navigation instruction 1130 and the next navigation instruction or action (e.g., turn right) at 1002B. Because the sensor 570 component detects the other vehicle 1214, the HUD component 100 may project the avatar 1002B in a corresponding color, such as red. In other words, the controller component 104 may select a color for a graphic element to be projected by the HUD component 100 based on object information or environment information (e.g., collected or detected by the sensor component 570). The pointer 1002A of FIG. 12B may continue pointing or tracking the other vehicle 1214 by rotating along a z-axis in a manner corresponding to a tracked object. In other words, the controller component 104 may adjust a yaw of the pointer graphic element 1002A.

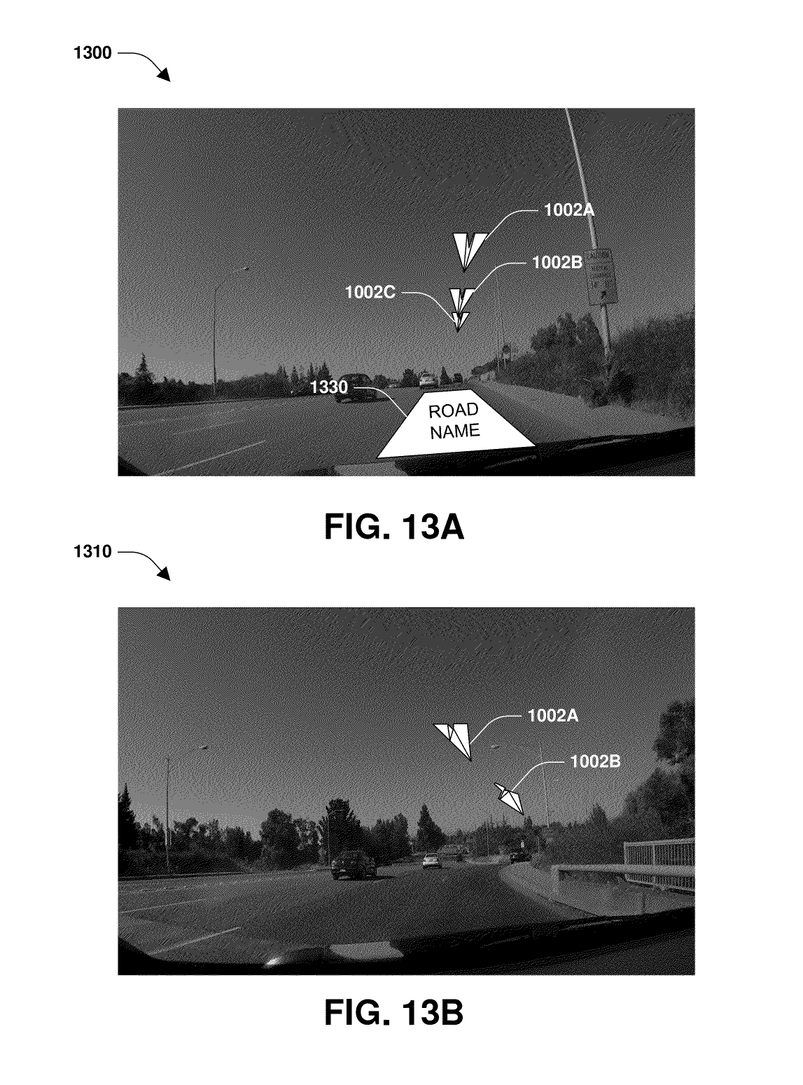

FIG. 13A is an illustration of an example scenario 1300 associated with 3-D navigation, according to one or more embodiments. While an individual or driver is driving a vehicle, the navigation component 540 may determine a current location of a vehicle and/or corresponding coordinates. Utilizing this information, the navigation component 540 or controller component 104 may determine a name of a road and have the HUD component 100 project the road name on a focal plane corresponding to a surface of the road or road segment, as seen at 1330. As discussed herein, projection of the graphic element on the road surface may be done in a manner which appears stationary with respect to the vehicle or in a manner which appears to move with the vehicle. In one or more embodiments, the HUD component 100 may project the road name 1330 in response to a query from an occupant of the vehicle, such as “What road am I on?”, for example. Additionally, other graphic elements, information, or highlighting may be projected on landmarks, objects, etc.

In FIG. 13A, multiple graphic elements or avatars are projected by the HUD component 100 and may be animated, collapsed, expanded, etc. as previously discussed. In this way, avatars 1002A, 1002B, and 1002C may be provided to guide a driver of a vehicle or other occupants along a route to a destination. FIG. 13B is an illustration of an example scenario 1310 associated with 3-D navigation, according to one or more embodiments. Here, it may be seen that avatars 1002A and 1002B are projected with varying pitch angles, roll angles, or yaw angles. The controller component may select or adjust a pitch, a roll, or a yaw angle for an avatar or a graphic element based on a trajectory of a path, a radius of an upcoming turn, a current velocity of a vehicle, a speed limit associated with an upcoming turn, suggested navigation action, information from the environment, distance until next navigation instruction or action, etc.

Here, in this example, because a proposed route has the vehicle taking an upcoming exit ramp with a circular road pattern or road segment, controller component 104 may have the HUD component project avatar 1002B with a greater roll angle or yaw angle than avatar 1002A, thereby providing a perception that there is an upcoming right turn. Additionally, the controller component 104 may select a shorter distance between the focal planes for avatars 1002A and 1002B to indicate how tight a turn may be. In other embodiments, the controller component 104 may select a color such as yellow or orange for one or more of the avatars to indicate an upcoming turn and/or a corresponding reason for a driver to slow down, for example.

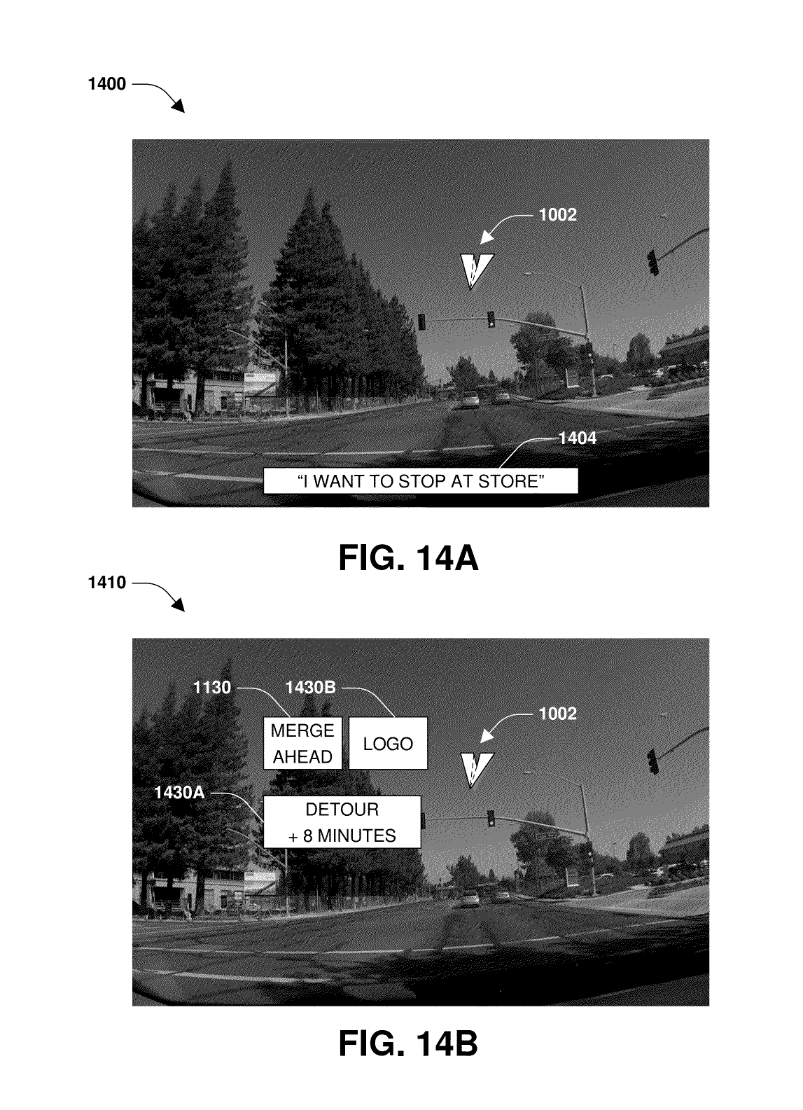

FIG. 14A is an illustration of an example scenario 1400 associated with 3-D navigation, according to one or more embodiments. A driver or occupant may provide a system 500 for 3-D navigation with a request or a command while engaged in navigation from an origin location to a destination location. In other words, the navigation component 540 may support addition of one or more waypoints between the origin location and the destination location such that navigation to the destination location is not interrupted in a manner which requires re-setting up of the navigation to the destination location. Explained another way, when a waypoint is inserted, the navigation component 540 may calculate a revised route from a current location of the vehicle to the waypoint and from the waypoint to the destination location (which was previously determined). In FIG. 14A, navigation from an origin location to a destination location is ongoing, as indicated by the avatar 1002, which is directing the driver of the vehicle to continue straight through the current intersection. At 1404, confirmation of the request or command may be projected in a text box. In one or more embodiments, the controller component 104 may not have the HUD component 100 project the text box 1404, such as when multiple obstacles are detected by sensor component 570, the vehicle is travelling over a threshold velocity, or based on user preferences, for example.

In one or more embodiments, the system 500 may interface with one or more additional components, servers, other systems, such as a mobile device or remote servers to determine one or more of the waypoints. For example, a driver may request the system 500 to “take me to the nearest gas station”, “the cheapest gas station nearby”, or “a gas station on my way home”. According to these requests, the controller component 104 may interface with the navigation component 540 to determine a current location for the vehicle, a destination location, a route between the current location and the destination location, a gas price application, such as an application on a mobile device, etc. to determine pricing, location, or other criteria.

FIG. 14B is an illustration of an example scenario 1410 associated with 3-D navigation, according to one or more embodiments. The controller component 104 may determine a location of a waypoint or select an appropriate waypoint from one or more available waypoints in conjunction with the navigation component 540. The navigation component 540 may calculate or reroute the vehicle to the waypoint as a current destination location and set the previous destination location as the next destination location. The navigation component 540 may calculate additional travel time associated with the waypoint. To this end, the HUD component 100 may project this information (e.g., detour which will add approximately eight minutes extra drive time) in text box 1430A. As discussed herein, the HUD component 100 may provide or project navigation instructions 1130 and an avatar 1002 on one or more focal planes in the environment. Further, the navigation component 540 may utilize a telematics channel to receive or download metadata or information associated with a waypoint or destination. For example, the navigation component 540 may receive a logo associated with the waypoint, such as a logo for a store or a gas station, etc. The HUD component 100 may project this logo or other related information at 1430B. Further, the HUD component 100 may animate one or more aspects, such as by folding the logo 1430B into a plane shape or otherwise transforming the logo 1430B into the avatar 1002 or other graphical element. The HUD component 100 may animate, transform, transition, etc. most any graphical element into most any other graphical element.

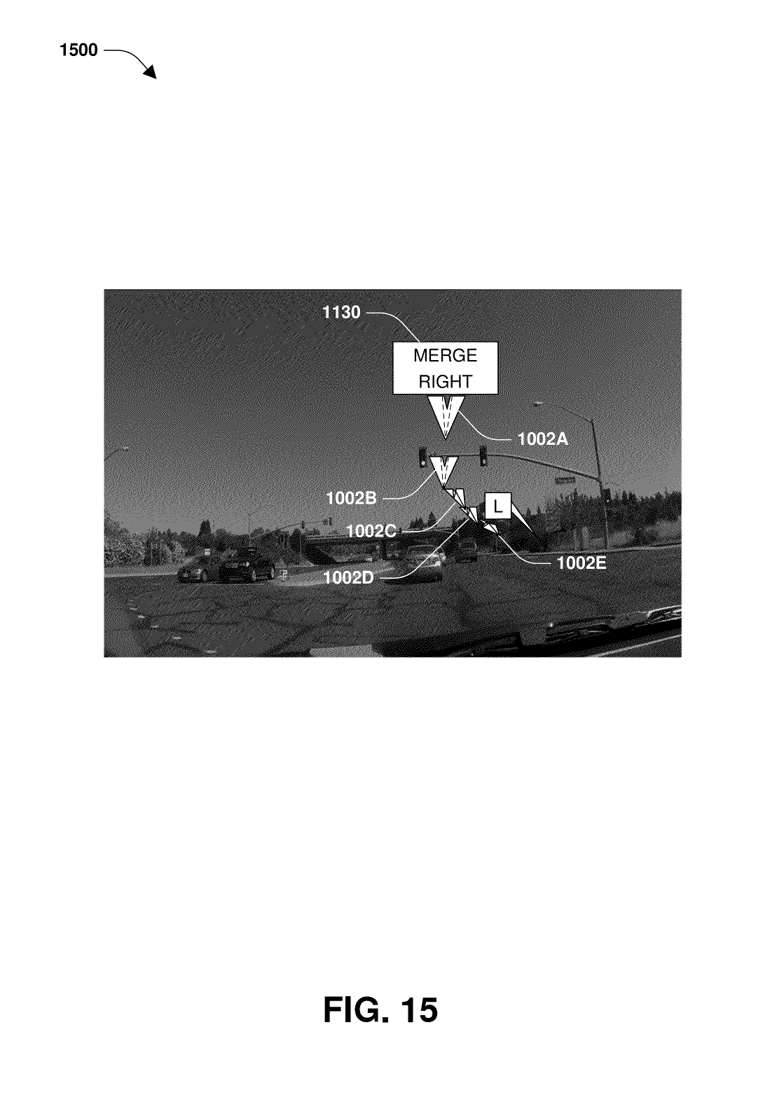

FIG. 15 is an illustration of an example scenario 1500 associated with 3-D navigation, according to one or more embodiments. The HUD component 100 may project navigation instructions in a text box 1130 and one or more avatars 1002A, 1002B, 1002C, 1002D, 1002E, etc. Additionally, the HUD component 100 may emphasize a route or path provided by respective avatars 1002A, 1002B, 1002C, 1002D, or 1002E by sequentially flashing the avatars, for example. The HUD component 100 may project one or more of the avatars 1002A, 1002B, 1002C, 1002D, or 1002E such that they appear to navigate, drive, or move around objects detected by the sensor component 570, such as hazards, road conditions, or other vehicles. The logo 1430B of FIG. 14B may be animated to shrink to an icon sized logo “L”, as seen in FIG. 15. For example, the controller component 104 may determine a time period for the logo 1430B to be displayed at a first size or full size. After expiration of the time period, the HUD component 100 may project the logo “L” at a smaller size, icon size, or a second size. The controller component 104 may determine the time period for the logo based on the distance to the corresponding object (e.g., restaurant, store, landmark, etc.).

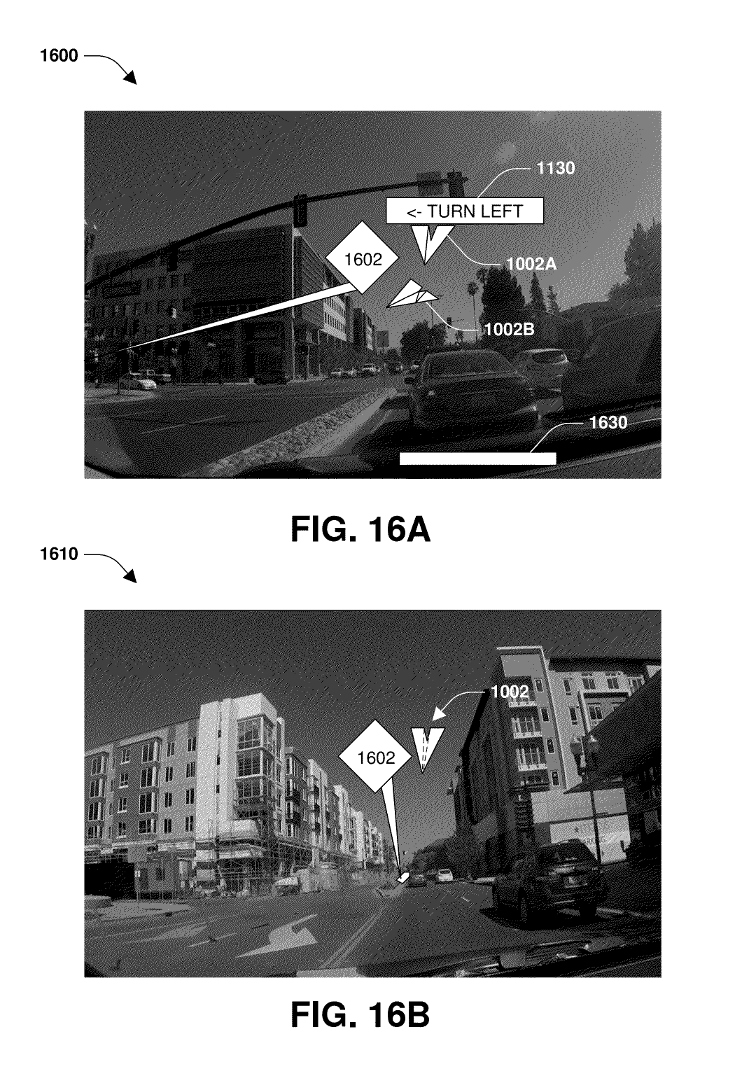

In one or more embodiments, early warning detection may be provided for one or more obstacles or objects not yet in view or range of an occupant of a vehicle, such as when the occupant is looking out of the front of the vehicle through the windshield. FIG. 16A is an illustration of an example scenario 1600 associated with 3-D navigation, according to one or more embodiments. In this example, traffic condition information may be received by the vehicle control component 180 for one or more traffic conditions along a route on which a vehicle is travelling or is anticipated to travel along. Here, the vehicle control component 180 may receive traffic condition information indicative of construction along one or more route portions of a route ahead of the vehicle. In other words, construction is taking place along a road segment on which the vehicle will take if navigation instructions are followed. Explained another way, occurrence of this construction may be received by the vehicle control component 180 prior to the vehicle arriving at the construction.

The HUD component 100 may project navigation instructions 1130 which may include text, arrows, blinking arrows, etc. Avatars 1002A and 1002B may be projected as well. In one or more embodiments, the controller component 104 may determine a stopping point or line where a driver is suggested to stop the vehicle. For example, the controller 104 may determine the stopping point based on a position of another vehicle, obstacles in the environment, other environment information, etc. The controller component 104 may have the HUD component 100 project this as a horizontal line 1630 to promote safe driving. In other embodiments, the HUD component 100 may project a vertical line or other graphical element which may be indicative of a safe following distance between the driver's vehicle and another vehicle ahead, for example.

Accordingly, the controller component 104 may identify this obstacle (e.g., object) or traffic condition and cause the HUD component 100 to project an advance notification or early warning graphic element 1602. This enables the system 500 to alert a driver or occupant of a vehicle of one or more objects, hazards, obstacles, traffic conditions, etc. even when respective objects are not directly visible when viewed or looking out of the windshield of the vehicle. FIG. 16B is an illustration of an example scenario 1610 associated with 3-D navigation, according to one or more embodiments. It may be seen in FIG. 16B that the traffic condition or obstruction associated with 1602 is ahead in the distance, and may not be apparent to a driver of a vehicle. Accordingly, the HUD component 100 may identify the hazard, construction, or object (e.g., received by the vehicle control component 180) by projecting an advance notification graphic element 1602 which points to and identifies the construction relative to the vehicle. For example, in FIG. 16A, because the construction is left of the vehicle, the pointer or tail associated with the advance notification graphic element 1602 may point outside of the windshield viewing area, thereby alerting a driver or other occupant of the vehicle that construction is ahead.

The controller component 104 may determine one or more target positions, update, or adjust a target position for one or more of the graphic elements projected by the HUD component 100. For example, the controller component 104 may select or determine a target position for the advance notice graphic element 1602 based on a distance of the vehicle from the object associated with or pointed at by the advance notice graphic element 1602. Here, the controller component 104 may determine that the construction (e.g., object) associated with the advance notice graphic element 1602 is greater than a threshold distance away from the vehicle (e.g., utilizing the navigation component 540 to determine a current GPS position for the vehicle to compare to coordinates for the construction provided by the vehicle control component 180). Because the construction is determined to be greater than this threshold distance, the HUD component 100 may project the advance notice graphic element 1602 in the sky, utilizing a pointer having a length greater than a threshold length, rather than projecting a graphic element proximate, overlapping, or adjacent to the construction.

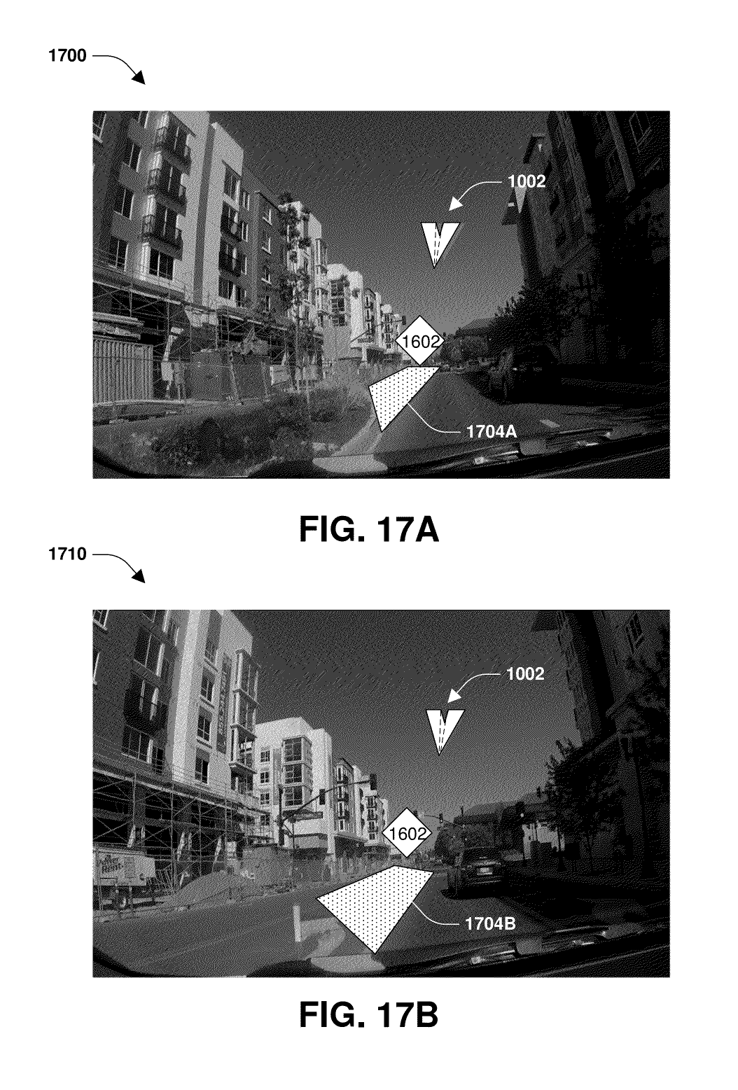

FIG. 17A is an illustration of an example scenario 1700 associated with 3-D navigation, according to one or more embodiments. As a vehicle approaches an object, such as the construction indicated by advance notice graphic element 1602, the controller component 104 may adjust the positioning or target position for the respective graphic element (e.g., 1602). Additionally, the controller component 104 may change the type of graphic element to be displayed. For example, as seen in FIG. 17A, the advance notice graphic element 1602 does not include a pointer, as previously utilized in FIG. 16A or FIG. 16B. Here, because of the proximity between the vehicle and the object (e.g., construction) is less than a threshold distance, the controller component 104 may determine that the pointer may be omitted. Here, the HUD component 100 may project avatar 1002, the advance notice graphic element 1602, and a hazard graphic element 1704A.

For example, when the vehicle control component 180 or the sensor component 540 identifies an object which is a hazard, obstruction, obstacle, or otherwise undriveable, such as a road segment under construction, etc., the controller component 104 may have the HUD component 100 project a hazard graphic element, such as the hazard graphic element 1704A in a manner which overlays the hazard. The depth buffering component 560 may facilitate inhibiting one or more portions of the hazard in the real world or environment such that the hazard is obscured from view of an occupant, operator, or driver of the vehicle. In other words, the HUD component 100 may project graphic elements which are opaque or have varying degrees of transparency. When the controller component 104 determines that an area, hazard, or object may not or should not be driven across or on, the HUD component 100 may project hazard graphic elements accordingly to “fill in” such areas.

FIG. 17B is an illustration of an example scenario 1710 associated with 3-D navigation, according to one or more embodiments. In FIG. 17B, it can be seen that the vehicle has approached the hazard or construction illustrated in FIG. 17A, and the HUD component 100 has adjusted the perspective of the hazard graphic element 1704B accordingly. For example, because the vehicle is closer in distance to the construction, the hazard graphic element 1704B of FIG. 17B is larger in area than the hazard graphic element 1704A of FIG. 17A. Information received from the sensor component 540 or the vehicle control component 180 relating to or associated with the hazard, construction, or objects in the environment may be utilized by the controller component 104 to determine a size, shape, model (e.g., guide icon, avatar, obscure, transparency, color), height, width, depth, focal plane, color, target position for a graphic element, or identify overlap between graphic elements or depth map information. In other words, these attributes may be based on object information or environment information received by the vehicle control component 180 or the sensor component 570. In one or more embodiments, the controller may select or change colors of graphic elements based on oncoming traffic, time of day, colors of objects in the environment, traffic rules, etc.

The depth map component 550 may manage or build a depth map of the environment or objects in the environment around a vehicle. The controller component 104 may utilize the depth map to determine whether or not an object should or should not be visible, transparent, opaque, etc. with regard to a graphic element. For example, the construction (hidden under hazard graphic element 1704A or 1704B) may include traffic barrels, traffic cones, debris, potholes, digging, undriveable road surfaces, etc. Here, in this example, the controller component 104 has made a determination that these aspects are to be hidden under the hazard graphic elements 1704A and 17048. However, other objects in the environment may not necessarily be hidden under or layered under the hazard graphic elements 1704A and 17048. For example, if a pedestrian crosses through the construction, the controller component 104 may determine that the pedestrian is an object which should not be obscured and have the HUD component 100 project the hazard graphic element 1704B such that the hazard graphic element 1704B does not obscure the pedestrian from view of the driver (e.g., when the pedestrian is walking ‘through’ the hazard graphic element 1704B). In other words, the controller component 104 may determine visibility, layering, transparency level, opaqueness level, etc. of a graphic element based on movement of an object within an environment or other data received from the sensor component 540 or the vehicle control component 180, such as identity of an object, object type, object size, etc., for example. In this way, depth map information may be utilized by the controller component 104 or the HUD component 100 to provide an occupant, operator, or driver of a vehicle a realistic perception of one or more graphic elements with respect to the surrounding environment or the real world.

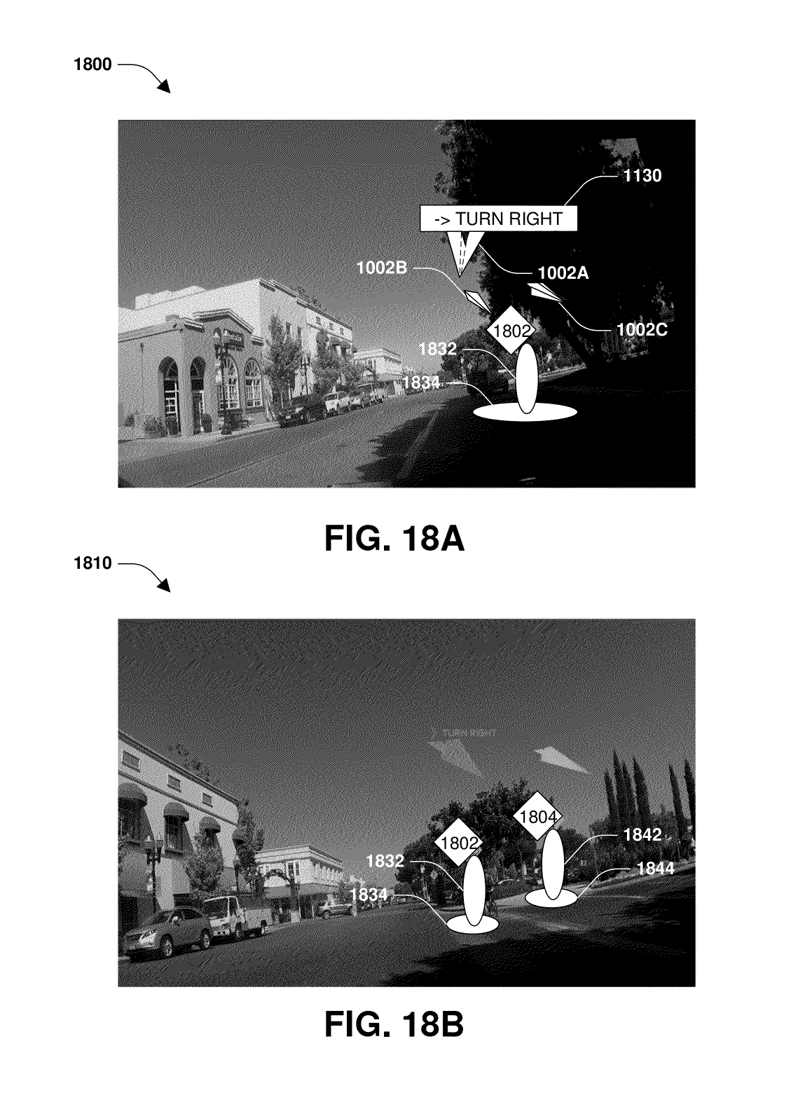

FIG. 18A is an illustration of an example scenario 1800 associated with 3-D navigation, according to one or more embodiments. When one or more objects are detected (e.g., by the sensor component 570) to be in a path of a vehicle or along an anticipated route (e.g., by environment information received by the vehicle control component 180), the controller component 104 may have the HUD component 100 highlight or track respective objects with graphic elements and/or pointers. For example, as a vehicle approaches a right turn, indicated by navigation instructions 1130 and avatars 1002A, 10028, and 1002C, the sensor component 570 may detect pedestrian 1832 near a road segment on which the vehicle is anticipated to turn. As a result of this, the controller component 104 may direct the HUD component 100 to project graphic element 1834 on the pedestrian 1832. In one or more embodiments, the HUD component 100 may project a graphic element over the pedestrian 1832. Further, the HUD component 100 may project a graphic element 1804 which illustrates signage indicative of a pedestrian road crossing.

As the vehicle and the pedestrian 1832 travel along the road segment, the relative distance between the two may change (e.g., the pedestrian 1832 may move, the vehicle may move, or both the pedestrian 1832 and the vehicle may move, etc.). The sensor component 570 may detect this change in distance and communicate the change or update the distance with the controller component 104 or the vehicle control component 180. The controller component 104 may update, change, or track target positions for one or more of the graphic elements (e.g., 1832 or 1834). In other words, the controller component 104 may adjust one or more focal planes for one or more of the graphic elements based on object information or environment information. As previously discussed, an actuator associated with projecting a graphic element on a focal plane may be controlled by the controller component 104 to move, adjust, or change the focal plane (e.g., moving the focal plane along a direction of line-of sight of a driver or occupant, such as line-of-sight 178 of FIG. 3).

FIG. 18B is an illustration of an example scenario 1810 associated with 3-D navigation, according to one or more embodiments. In FIG. 18, the HUD component 100 may project multiple graphic elements 1834 and 1844 for multiple pedestrians 1832 and 1842, respectively. Additionally, the HUD component 100 may project one or more graphic elements as indicators, such as at 1802 or 1804.

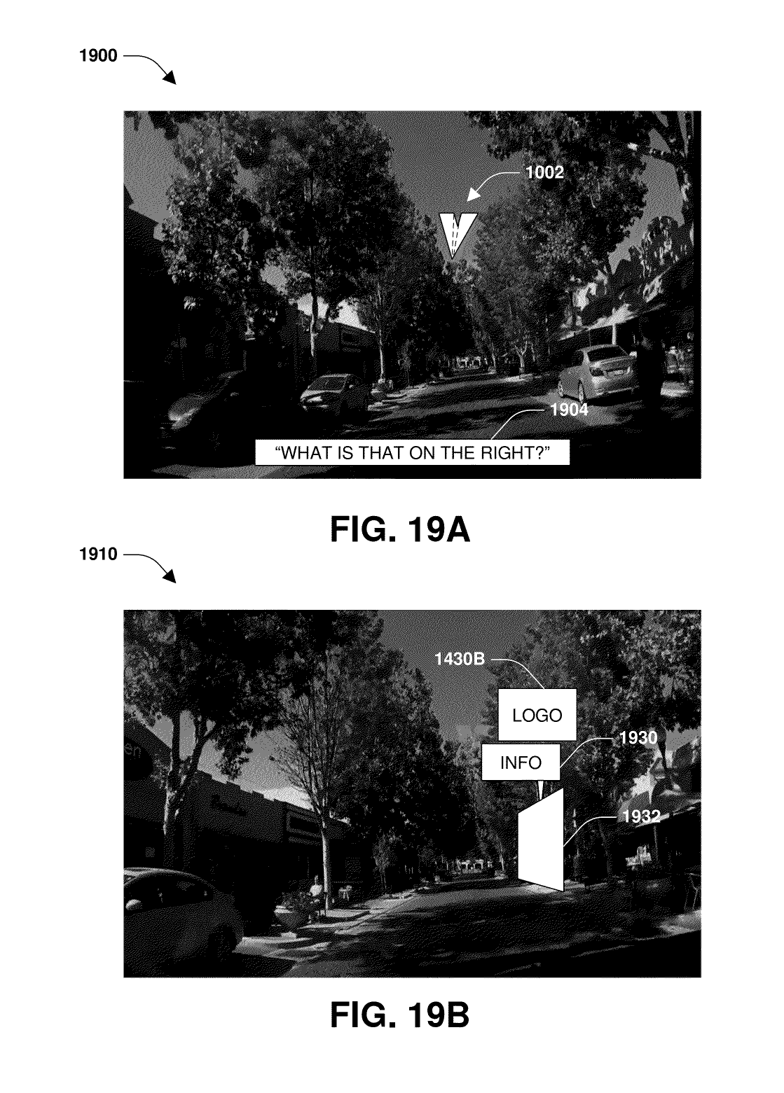

FIG. 19A is an illustration of an example scenario 1900 associated with 3-D navigation, according to one or more embodiments. In one or more embodiments, the system for 3-D navigation 500 may enable an occupant of a vehicle to interact with vehicle with respect to objects in the environment. In other words, an occupant may ask questions (“what is that”, “That looks neat”) or make comments (e.g., verbally or via text input) and receive graphical element projections as answers. For example, the sensor component 570 may accept one or more queries, requests, or commands from a user, occupant, or driver of a vehicle. Here, an occupant of the vehicle has asked, “What is that on the right?” The HUD component 100 may display confirmation or repeat the query or request using a text box graphic element 1904. In one or more embodiments, queries or requests may be enabled during navigation, as seen with avatar 1002. One or more other components may be employed to facilitate fulfillment of one or more of the requests or commands. For example, if a mobile device is communicatively coupled with the system 500, the controller component 104 may cause the mobile device to dial a telephone number of a business when ordered to “call the restaurant on the right”. As another example, the controller 104 may interact with a restaurant reservation application installed on the mobile device or on the vehicle in response to “make me a reservation at restaurant X”. Other commands or requests may utilize audio systems of the vehicle, such as “read me the menu”.

FIG. 19B is an illustration of an example scenario 1910 associated with 3-D navigation, according to one or more embodiments. The controller component 104 may process the request or route the request associated with 1904 to the navigation component 540, to determine objects within proximity of the vehicle, such as businesses, restaurants, etc. The controller component 104 may receive information associated with an object, such as a restaurant from a map application, a remote server, etc. This information may include metadata associated with the object, such as hours, a logo, a status, reviews for the business, contact information, a telephone number, a menu, etc. Here, the HUD component 100 may project a logo graphic element 1430B, information 1930 (e.g., telephone number, status, hours, etc.), and a highlighting graphic element 1932, which may draw attention to the location of the object (e.g., restaurant or business).

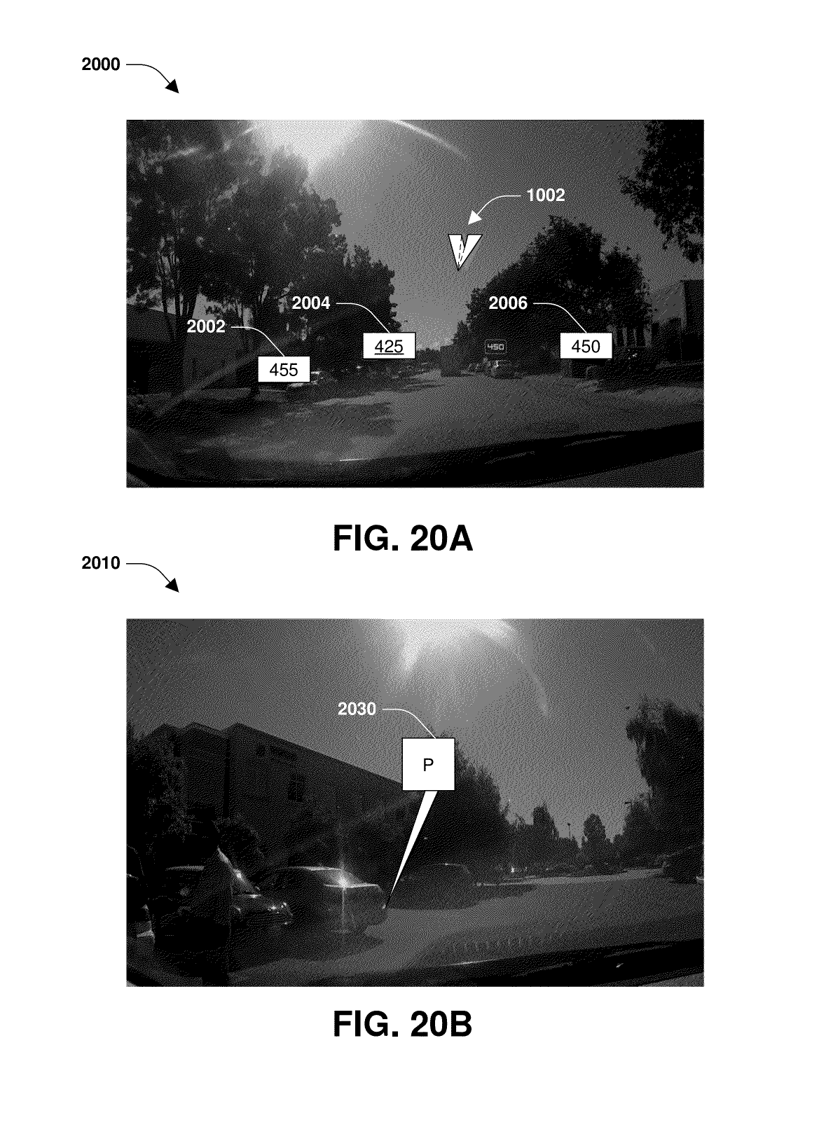

FIG. 20A is an illustration of an example scenario 2000 associated with 3-D navigation, according to one or more embodiments. In one or more embodiments, the navigation component 540 may provide the vehicle control component 180 with metadata associated with one or more objects in the environment. For example, one or more of the objects in the environment may be buildings or businesses. The navigation component 540 may download or receive address information for respective buildings or businesses, which may be projected as graphic elements by the HUD component 100. For example, addresses for buildings 2002, 2004, and 2006 may be presented by the HUD component 100. In one or more embodiments, the controller component 104 may enable address graphical element presentation when a vehicle is within a threshold distance of a destination location or upon user request, for example. In other embodiments, address graphical elements may be projects during navigation mode, such as when directions are being provided by the navigation component 540, as indicated by the avatar 1002.

FIG. 20B is an illustration of an example scenario 2010 associated with 3-D navigation, according to one or more embodiments. Here, in this example, the sensor component 570 or the navigation component 540 may identify one or more parking spots. As a result, the controller component 104 may have the HUD component 100 project a graphic element 2030 indicative of parking in view of an occupant of the vehicle. This graphic element 2030 may appear as an advance notification graphic element, include a pointer, have one or more transparency attributes, color, shape, size, etc., or include object metadata (e.g., cost of parking, time limit for spot, etc.) as described herein.

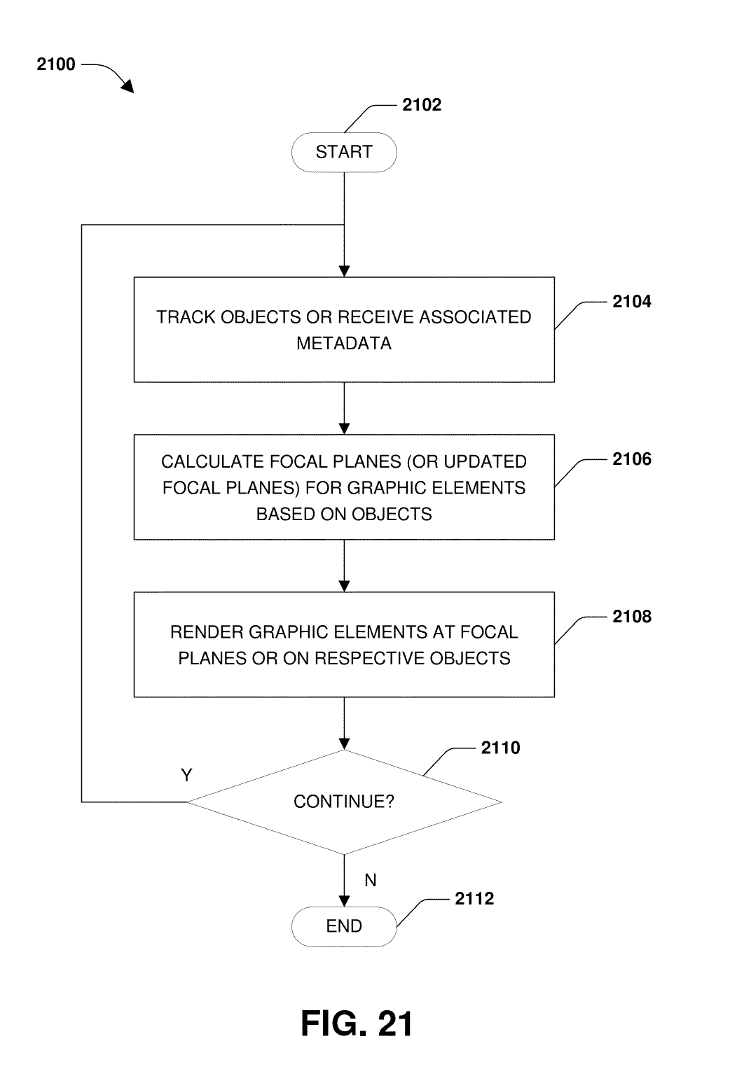

FIG. 21 is an illustration of an example flow diagram of a method 2100 for 3-D navigation, according to one or more embodiments. At 2102, the method 2100 starts. At 2104, one or more objects may be tracked or metadata associated with respective objects may be received. Additionally, information related to an environment or route from an origin location to a destination location may be received. At 2106, one or more focal planes or updated focal planes may be calculated for graphic elements to be projected in association with one or more of the objects. At 2108, one or more graphic elements may be rendered or projected at one or more of the focal planes or on respective objects. At 2110, a determination may be made as to whether or not to continue tracking or projecting graphic elements in association with one or more of the objects. If it is determined that additional tracking is desired, the method 2100 continues back to 2104. If no additional tracking is desired, the method may end at 2112.

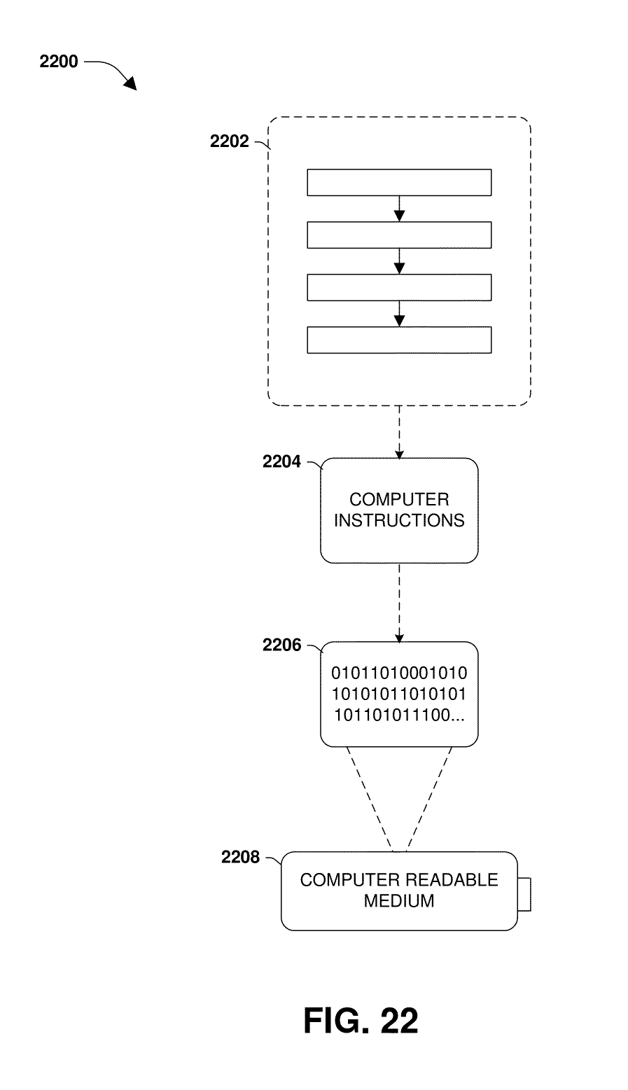

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 22, wherein an implementation 2200 includes a computer-readable medium 2208, such as a CD-R, DVD-R, flash drive, a platter of a hard disk drive, etc., on which is encoded computer-readable data 2206. This computer-readable data 2206, such as binary data including a plurality of zeroes or ones as shown in 2206, in turn includes a set of computer instructions 2204 configured to operate according to one or more of the principles set forth herein. In one such embodiment 2200, the processor-executable computer instructions 2204 are configured to perform a method 2202, such as the method 600 of FIG. 6 or the method 2100 of FIG. 21. In another embodiment, the processor-executable instructions 2204 are configured to implement a system, such as the system 500 of FIG. 5. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

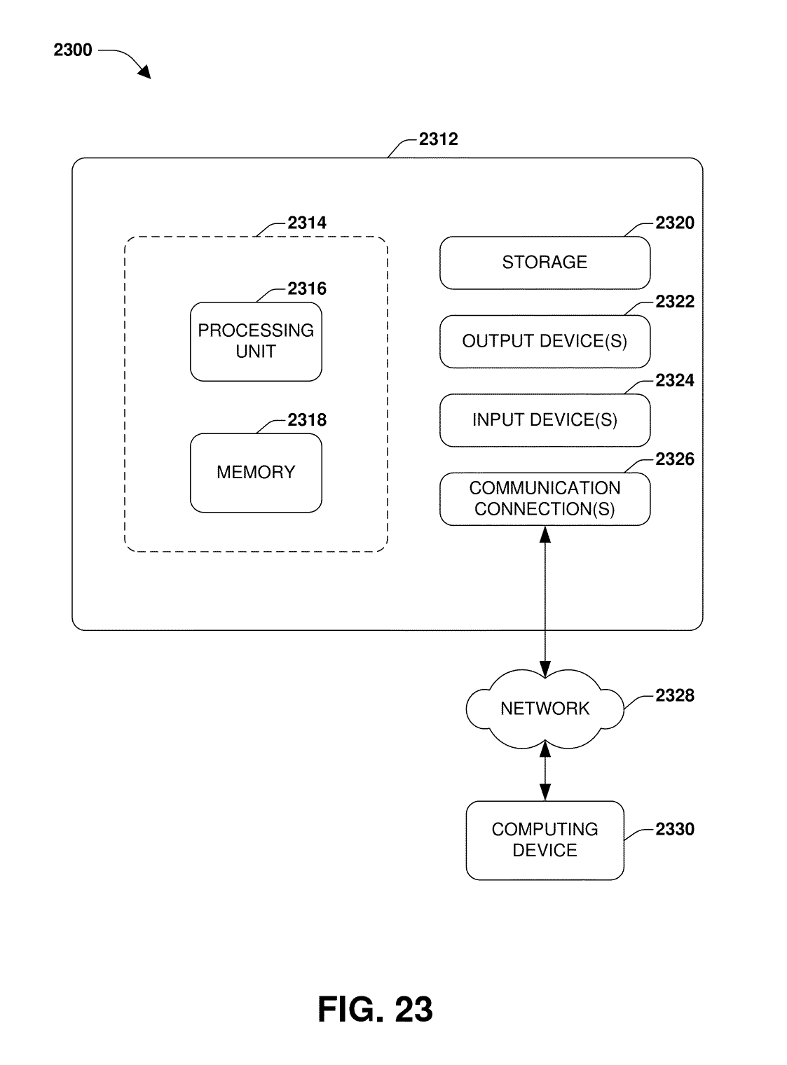

FIG. 23 and the following discussion provide a description of a suitable computing environment to implement embodiments of one or more of the provisions set forth herein. The operating environment of FIG. 23 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 23 illustrates a system 2300 including a computing device 2312 configured to implement one or more embodiments provided herein. In one configuration, computing device 2312 includes one or more processing units 2316 and memory 2318. Depending on the exact configuration and type of computing device, memory 2318 may be volatile, such as RAM, non-volatile, such as ROM, flash memory, etc., or a combination of the two. This configuration is illustrated in FIG. 23 by dashed line 2314.

In other embodiments, device 2312 includes additional features or functionality. For example, device 2312 can include additional storage such as removable storage or non-removable storage, including, but not limited to, magnetic storage, optical storage, and the like. Such additional storage is illustrated in FIG. 23 by storage 2320. In one or more embodiments, computer readable instructions to implement one or more embodiments provided herein are in storage 2320. Storage 2320 can store other computer readable instructions to implement an operating system, an application program, and the like. Computer readable instructions are loaded in memory 2318 for execution by processing unit 2316, for example.

The term “computer readable media” as used herein includes computer storage media. Computer storage media includes volatile and nonvolatile, removable and non-removable media implemented in any method or technology for storage of information such as computer readable instructions or other data. Memory 2318 and storage 2320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 2312. Any such computer storage media is part of device 2312.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 2312 includes input device(s) 2324 such as keyboard, mouse, pen, voice input device, touch input device, infrared cameras, video input devices, or any other input device. Output device(s) 2322 such as one or more displays, speakers, printers, or any other output device may be included with device 2312. Input device(s) 2324 and output device(s) 2322 are connected to device 2312 via a wired connection, wireless connection, or any combination thereof. In one or more embodiments, an input device or an output device from another computing device are used as input device(s) 2324 or output device(s) 2322 for computing device 2312. Device 2312 can include communication connection(s) 2326 to facilitate communications with one or more other devices.

According to one or more aspects, a system for 3-dimensional (3-D) navigation is provided, including a navigation component configured to receive an origin location and a destination location. The navigation component can be associated with a vehicle and configured to generate a route from the origin location to the destination location. One or more portions of the route can include one or more navigation instructions associated with one or more road segments or one or more intersections of the road segments. The system can include a heads-up display (HUD) component configured to project one or more graphic elements on one or more focal planes around an environment surrounding the vehicle. The HUD component can be configured to project one or more of the graphic elements in view of an occupant of the vehicle based on the route. The system can include a controller component configured to adjust a distance between one or more of the focal planes of one or more of the graphic elements and the vehicle based on one or more road conditions associated with one or more portions of the route and a current position of the vehicle.

In one or more embodiments, the controller component can be configured to adjust a target position for one or more of the graphic elements based on one or more of the road conditions and the current position of the vehicle. The system can include a vehicle control component configured to receive one or more of the road conditions. Additionally, the system can include a sensor component configured to detect one or more of the road conditions. A road condition of the one or more road conditions can include traffic information of one or more of the road segments or speed limit information associated with one or more of the road segments. Additionally, road conditions may include an obstruction, an obstacle, a pedestrian, debris, or a pothole, for example.

The system can include a depth map component configured to build a depth map of the environment surrounding the vehicle. The HUD component can be configured to project one or more of the graphic elements based on the depth map of the environment. The depth map component may be configured to build the depth map based on depth information. In one or more embodiments, the system can include a sensor component configured to detect depth information from the environment surrounding the vehicle. The depth map component may be configured to receive the depth map based on a telematics channel. The system can include a depth buffering component configured to enable or disable rendering of one or more portions of one or more of the graphic elements based on the depth map.

The HUD component may be configured to project one or more graphic elements as a moving avatar or as a placeholder, such as a flag pole, marker, identifier, etc.

According to one or more aspects, a method for 3-dimensional (3-D) navigation is provided, including generating a route from an origin location to a destination location for a vehicle. One or more portions of the route can include one or more navigation instructions associated with one or more road segments or one or more intersections of the road segments. The method can include projecting one or more graphic elements on one or more focal planes around an environment surrounding the vehicle. One or more of the graphic elements may be projected in view of an occupant of the vehicle based on the route. The method can include adjusting a distance between one or more of the focal planes of one or more of the graphic elements and the vehicle based on one or more road conditions associated with one or more portions of the route and a current position of the vehicle. One or more portions of the method can be implemented via a processing unit.

The method can include adjusting a target position for one or more of the graphic elements based on one or more of the road conditions and the current position of the vehicle. The method can include receiving or detecting one or more of the road conditions. A road condition of the one or more road conditions can include traffic information of one or more of the road segments, speed limit information associated with one or more of the road segments, an obstruction, an obstacle, a pedestrian, debris, or a pothole.

The method can include building a depth map of the environment surrounding the vehicle, projecting one or more of the graphic elements based on the depth map of the environment, detecting depth information from the environment surrounding the vehicle, building the depth map based on the detected depth information, enabling or disabling rendering of one or more portions of one or more of the graphic elements based on the depth map, among other things.

According to one or more aspects, a computer-readable storage medium including computer-executable instructions, which when executed via a processing unit on a computer performs acts, including generating a route from an origin location to a destination location for a vehicle, wherein one or more portions of the route include one or more navigation instructions associated with one or more road segments or one or more intersections of the road segments, projecting one or more graphic elements on one or more focal planes around an environment surrounding the vehicle, wherein one or more of the graphic elements are projected in view of an occupant of the vehicle based on the route, or adjusting a distance between one or more of the focal planes of one or more of the graphic elements and the vehicle based on one or more road conditions associated with one or more portions of the route and a current position of the vehicle.

In one or more embodiments, projecting one or more of the graphic elements utilizes rastor based graphics. Additionally, one or more of the embodiments can include providing one or more of the navigation instructions via projecting one or more of the graphic elements as a moving avatar or animating the moving avatar by sequentially projecting the moving avatar on one or more different focal planes.

According to one or more aspects, a system for 3-dimensional (3-D) navigation is provided, including a sensor component, a heads-up display (HUD) component, and a controller component. The sensor component may track one or more objects in an environment surrounding a vehicle and one or more corresponding coordinates for respective objects relative to the vehicle. The HUD component may project, render, present, or display one or more graphic elements on one or more focal planes corresponding to one or more of the objects, wherein one or more of the graphic elements are projected in view of an occupant of the vehicle. The controller component may calculate one or more updated focal planes for one or more of the graphic elements based on one or more of the coordinates for respective objects.

In one or more embodiments, the HUD component may project one or more of the graphic elements on one or more of the updated focal planes for one or more of the objects. Additionally, the HUD component may cease projecting one or more of the graphic elements on one or more of the focal planes upon projecting on one or more of the updated focal planes. One or more of the graphic elements may include a pointer having information associated with one or more of the objects on which one or more of the graphic elements is projected. One or more of the objects may be an obstruction, an obstacle, a pedestrian, a construction zone, a landmark, a building, a business, or a parking spot.

The system may include a vehicle control component determining a size, a shape, a model, a color, or one or more attributes for one or more of the graphic elements. The vehicle control component may manage overlap between two or more of the graphic elements. The system may include a navigation component generating a route from an origin location to a destination location and a vehicle control component receiving information associated with one or more of the objects along the route, wherein one or more of the objects are businesses. The HUD component may project one or more of the graphic elements as a logo associated of one or more of the businesses. In one or more embodiments, the sensor component may include a navigation component or utilize telematics.

According to one or more aspects, a system for 3-dimensional (3-D) navigation is provided, including a navigation component, a controller component, and a heads-up display (HUD) component. The navigation component may receive metadata associated with one or more objects in an environment surrounding a vehicle, a layout for respective objects within the environment, and a current location of the vehicle relative to the layout. The controller component may calculate one or more focal planes for one or more graphic elements based on the layout of one or more of the objects and the current location of the vehicle. The HUD component may project, render, present, or display one or more of the graphic elements on one or more of the focal planes corresponding to one or more of the objects, wherein one or more of the graphic elements are projected in view of an occupant of the vehicle.

One or more of the graphic elements may include a pointer presenting at least a portion of the metadata associated with one or more of the objects on which one or more of the graphic elements is projected. The metadata may include a telephone number, an address, a rating, a name of a business, hours of operation, or a status associated with an object. The HUD component may project one or more of the graphic elements based on the layout of one or more of the objects and the current location of the vehicle. Additionally, the HUD component may shift from projecting a layout view or a birds-eye-view to projecting a first-person view or a third-person view.

The system may include a sensor component receiving a query from the occupant of the vehicle associated with one or more of the objects, wherein the HUD component projects one or more portions of corresponding metadata for one or more of the objects associated with the query in response to the query. The navigation component may generate a route from an origin location to a destination location, wherein the HUD component renders one or more of the graphic elements as an avatar which leads the occupant along the route. The controller component may calculate a pitch angle, roll angle, yaw angle, or velocity for the avatar (or other graphic elements). The HUD component may present, display, or render one or more of the graphic elements as a road name based on the metadata and the current location of the vehicle.

According to one or more aspects, a method for 3-dimensional (3-D) navigation is provided, including tracking one or more objects in an environment surrounding a vehicle and determining one or more corresponding coordinates for respective objects relative to the vehicle, calculating one or more focal planes for one or more graphic elements based on one or more of the coordinates for respective objects, and rendering one or more of the graphic elements on one or more of the focal planes corresponding to one or more of the objects, wherein one or more of the graphic elements are projected in view of an occupant of the vehicle. The tracking, the calculating, or the rendering may be implemented via a processing unit.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for 3-dimensional (3-D) navigation, comprising:
a sensor component tracking one or more objects in an environment surrounding a vehicle and one or more corresponding coordinates for respective objects relative to the vehicle;
a heads-up display (HUD) component projecting one or more graphic elements on one or more focal planes corresponding to one or more of the objects, wherein one or more of the graphic elements are projected in view of an occupant of the vehicle; and
a controller component calculating one or more updated focal planes for one or more of the graphic elements based on one or more of the coordinates for respective objects.

2. The system of claim 1, wherein the HUD component projects one or more of the graphic elements on one or more of the updated focal planes for one or more of the objects.

3. The system of claim 2, wherein the HUD component ceases projecting one or more of the graphic elements on one or more of the focal planes upon projecting on one or more of the updated focal planes.

4. The system of claim 1, wherein one or more of the graphic elements comprises a pointer having information associated with one or more of the objects on which one or more of the graphic elements is projected.

5. The system of claim 1, wherein one or more of the objects is an obstruction, an obstacle, a pedestrian, a construction zone, a landmark, a building, a business, or a parking spot.

6. The system of claim 1, comprising a vehicle control component determining a size, a shape, a model, a color, or one or more attributes for one or more of the graphic elements.

7. The system of claim 1, comprising a vehicle control component managing overlap between two or more of the graphic elements.

8. The system of claim 1, comprising a navigation component generating a route from an origin location to a destination location.

9. The system of claim 8, comprising a vehicle control component receiving information associated with one or more of the objects along the route, wherein one or more of the objects are businesses.

10. The system of claim 9, wherein the HUD component projects one or more of the graphic elements as a logo associated of one or more of the businesses.

11. A system for 3-dimensional (3-D) navigation, comprising:
a navigation component receiving metadata associated with one or more objects in an environment surrounding a vehicle, a layout for respective objects within the environment, and a current location of the vehicle relative to the layout;
a controller component calculating one or more focal planes for one or more graphic elements based on the layout of one or more of the objects and the current location of the vehicle; and
a heads-up display (HUD) component projecting one or more of the graphic elements on one or more of the focal planes corresponding to one or more of the objects, wherein one or more of the graphic elements are projected in view of an occupant of the vehicle.

12. The system of claim 11, wherein one or more of the graphic elements comprises a pointer presenting at least a portion of the metadata associated with one or more of the objects on which one or more of the graphic elements is projected.

13. The system of claim 11, wherein the metadata comprises a telephone number, an address, a rating, a name of a business, hours of operation, or a status associated with an object.

14. The system of claim 11, wherein the HUD component projects one or more of the graphic elements based on the layout of one or more of the objects and the current location of the vehicle.

15. The system of claim 14, wherein the HUD component shifts from projecting a layout view to projecting a first-person view or a third-person view.

16. The system of claim 11, comprising a sensor component receiving a query from the occupant of the vehicle associated with one or more of the objects, wherein the HUD component projects one or more portions of corresponding metadata for one or more of the objects associated with the query in response to the query.

17. The system of claim 11, wherein the navigation component generates a route from an origin location to a destination location, wherein the HUD component renders one or more of the graphic elements as an avatar which leads the occupant along the route.

18. The system of claim 17, wherein the controller component calculates a pitch angle, roll angle, yaw angle, or velocity for the avatar.

19. The system of claim 11, wherein the HUD component renders one or more of the graphic elements as a road name based on the metadata and the current location of the vehicle.

20. A method for 3-dimensional (3-D) navigation, comprising:
tracking one or more objects in an environment surrounding a vehicle and determining one or more corresponding coordinates for respective objects relative to the vehicle;
calculating one or more focal planes for one or more graphic elements based on one or more of the coordinates for respective objects; and
rendering one or more of the graphic elements on one or more of the focal planes corresponding to one or more of the objects, wherein one or more of the graphic elements are projected in view of an occupant of the vehicle,
wherein the tracking, the calculating, or the rendering is implemented via a processing unit.
